(19) United States
(12) Patent Application Publication
(10) Pub. No.: US 2025/0392596 A1
(43) Pub. Date: Dec. 25, 2025

(54) VIRTUAL MEETING SPACE

(71) Applicant: Wells Fargo Bank, N.A., San Francisco, CA (US)

(72) Inventors: Harrison Thomas, San Francisco, CA (US); Dennis E. Montenegro, Concord, CA (US); Clynton Taylor, San Francisco, CA (US); Konstantin Zheludkov, San Francisco, CA (US)

(21) Appl. No.: 17/964,879

(22) Filed: Oct. 12, 2022

(51) Int. Cl. H04L 9/40

(52) U.S. Cl. CPC H04L 63/101; H04L 63/08

(57) ABSTRACT

A method that includes a service computing system generating a virtual meeting space within a virtual environment and the service computing system receiving from a first party computing system a first party entrance request of a first party to enter into the virtual meeting space. The method further includes the service computing system comparing the first party identifier to a recorded first party identifier and, based on the first party identifier matching the recorded first party identifier, authorizing the first party into the virtual meeting space. The method further includes, in response to authorizing the first party into the virtual meeting space, the service computing system projecting information on a virtual display screen within the virtual meeting space. The method further includes the service computing system recording input from the first party within the virtual meeting space into an artifact and tokenizing at least a portion of the artifact.

### TECHNICAL FIELD

The present implementations relate generally to a virtual meeting space within a virtual environment.

### BACKGROUND

A virtual environment may include multiple avatars as virtual representations of multiple users. Each of the users may control its corresponding avatar using a user device. The multiple avatars of the multiple users may have some form of interaction among some or all of the multiple avatars in the virtual environment.

### SUMMARY

Various arrangements related to a method that includes a service computing system generating a virtual meeting space within a virtual environment. The method further includes the service computing system receiving from a first party computing system a first party entrance request of a first party to enter into the virtual meeting space. The first party entrance request includes a first party authentication token. The first party authentication token includes a first party identifier. The method further includes the service computing system comparing the first party identifier to a recorded first party identifier. The method further includes, based on the first party identifier matching the recorded first party identifier, the service computing system authorizing the first party into the virtual meeting space. The method further includes, in response to authorizing the first party into the virtual meeting space, the service computing system projecting information on a virtual display screen within the virtual meeting space. The method further includes the service computing system recording using a user device input from the first party within the virtual meeting space into an artifact. The method further includes the service computing system tokenizing at least a portion of the artifact.

Various arrangements related to a system that includes one or more processors that generate a virtual meeting space within a virtual environment and receive a first party entrance request of a first party to enter into the virtual meeting space. The first party entrance request includes a first party authentication token. The first party authentication token includes a first party identifier. The one or more processors compare the first party identifier to a recorded first party identifier and, based on the first party identifier matching the recorded first party identifier, authorize the first party into the virtual meeting space. The one or more processors further, in response to authorizing the first party into the virtual meeting space, project information on a virtual display screen within the virtual meeting space, record input from the first party within the virtual meeting space into an artifact, and tokenize at least a portion of the artifact.

Various arrangements related to a non-transitory computer-readable storage media storing instructions that are executable by one or more processors to perform operations. The operations include a service computing system generating a virtual meeting space within a virtual environment and the service computing system receiving from a first party computing system a first party entrance request of a first party to enter into the virtual meeting space. The first party entrance request includes a first party authentication token. The first party authentication token includes a first party identifier. The operations further include the service computing system comparing the first party identifier to a recorded first party identifier. The operations further include, based on the first party identifier matching the recorded first party identifier, the service computing system authorizing the first party into the virtual meeting space. The operations further include, in response to authorizing the first party into the virtual meeting space, the service computing system projecting information on a virtual display screen within the virtual meeting space. The operations further include the service computing system recording using a user device input from the first party within the virtual meeting space into an artifact. The operations further include the service computing system tokenizing at least a portion of the artifact.

### BRIEF DESCRIPTION OF THE DRAWINGS

FIG. 1 is a virtual environment, according to some arrangements;

FIG. 2 is the virtual environment of FIG. 1, according to some arrangements;

FIG. 3 is a system capable of implementing a virtual meeting space in a virtual environment, according to some arrangements;

FIG. 4 is a communications diagram of the system, according to some arrangements;

FIG. 5 is a flow diagram of a method for facilitating a meeting in the virtual meeting space, according to some arrangements;

FIG. 6 is a flow diagram of a method for processing a second party entrance request, according to some arrangements;

FIG. 7 is a flow diagram of a method for evaluating the first party 302 with a blacklist, according to some arrangements;

FIG. 8 is a flow diagram of a method for evaluating the first party 302 with a whitelist, according to some arrangements;

FIG. 9 is a flow diagram of a method for tokenizing the first party input, according to some arrangements;

FIG. 10 is a flow diagram of a method for processing a display request, according to some arrangements;

FIG. 11 is a flow diagram of a method for processing a modification request, according to some arrangements;

FIG. 12 is a flow diagram of a method for evaluating the first party state, according to some arrangements; and

FIG. 13 is a flow diagram of a method for evaluating the first party condition, according to some arrangements.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein and illustrated in the figures, can be arranged, substituted, combined, and designed in a wide variety of different configurations, all of which are explicitly contemplated and made part of this disclosure.

### DETAILED DESCRIPTION

In a process of forming an agreement in a virtual environment, parties may have a misunderstanding of the agreement due to different interpretations of the agreement. Furthermore, a party may be scammed by forming an agreement with a fraudulent contracting party.

Referring to the figures generally, systems, apparatuses, and non-transitory computer-readable media and methods for a virtual meeting space in virtual environments are described herein. In some examples, entrance of avatars of parties into the virtual meeting space requires authentication of the parties and an evaluation of background checks of the parties. Furthermore, at least a portion of the input of the parties, detected and recorded by user devices or computing systems, such as a sound, a video, a body gesture, a face gesture, an eye gesture, or the like, within a physical space associated with the virtual meeting space, may be tokenized to memorialize meeting of the parties in the virtual meeting space.

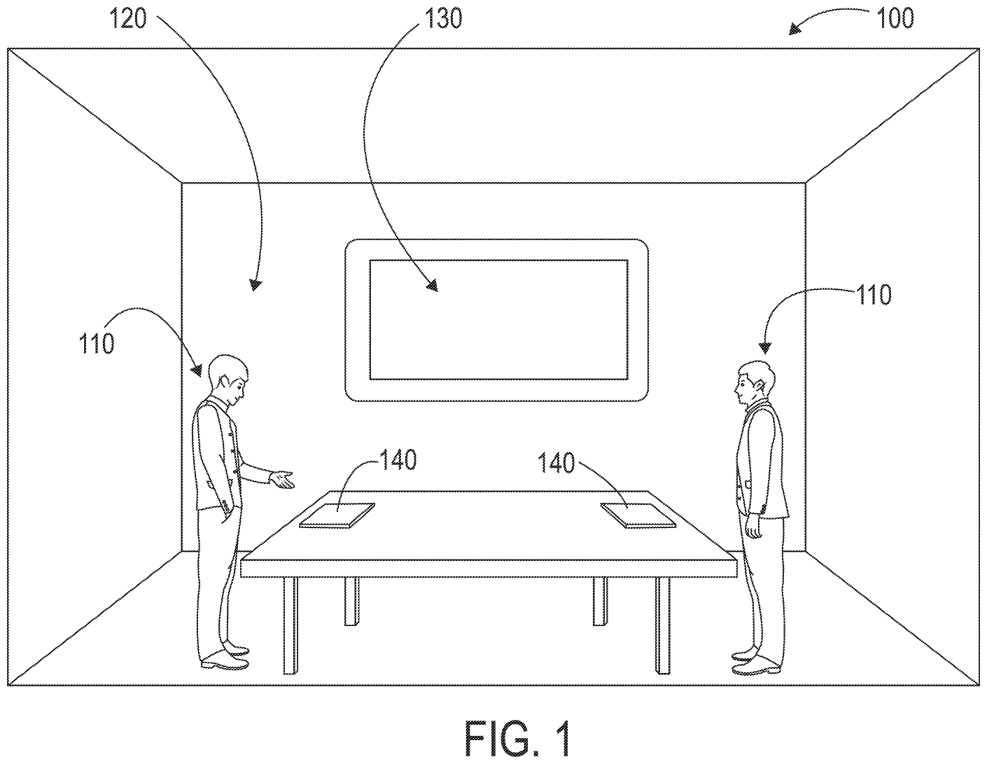

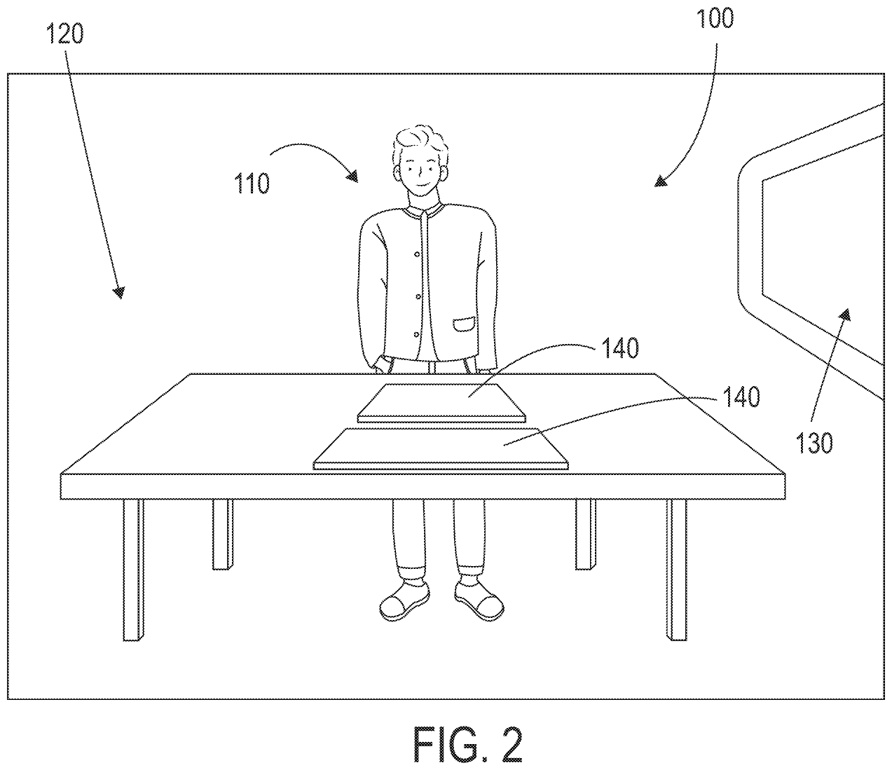

Referring to FIGS. 1 and 2, a virtual environment 100 (e.g., a 3D space, a virtual world, a metaverse, etc.) is shown according to some arrangements. In some arrangements, the virtual environment 100 may be an Augmented Reality (AR), where non-interactive virtual elements are displayed and viewed with physical elements in a physical space (e.g., a physical world, a real world, a physical reality, etc.). In some arrangements, the virtual environment 100 may be a Virtual Reality (VR), where interactive virtual elements and the non-interactive virtual elements are displayed and viewed within a virtual space (e.g., a virtual world, a non-physical world, etc.). The interactive and the non-interactive virtual elements may graphically depict accurate or inaccurate representations of physical elements in the physical space. In some arrangements, the virtual environment 100 may be a mixed reality (MR), having a combination (e.g., a mix, etc.) of AR and VR, where the interactive and the non-interactive virtual elements are displayed and viewed with physical elements in a physical space. In some arrangements, the virtual environment 100 may be mapped to an outlined physical space (e.g., a room, a building, a city, a planet, etc.) such that virtual coordinates of the virtual environment 100 can be mapped or matched to (e.g., aligned with, become in-sync with, etc.) physical coordinates of the outlined physical space, for example, based on one or more matrices or transform functions that can convert physical coordinates to virtual coordinates, and vice versa.

The physical coordinates may be 2D (e.g., two-dimensional) in the physical space and can be defined by coordinates on a plane (e.g., on an x-y, x-z, or y-z plane) of the physical space. The virtual coordinates may be 2D in the virtual environment 100 and can be defined by coordinates on a plane (e.g., on an x-y, x-z, or y-z plane) in the virtual environment 100. The physical coordinates may be 3D (e.g., three-dimensional) in the physical space and can be defined by coordinates in a space (e.g., in an x-y-z space) of the physical space. The virtual coordinates may be 3D in the virtual environment 100 and can be defined by coordinates in a space (e.g., in an x-y-z space) of the virtual environment 100. A physical location of the user in the physical space can be represented by a point defined by a set of physical coordinates.

The virtual environment 100 includes an avatar 110 (e.g., an icon, a symbol, a figure, etc.). In some arrangements, the virtual environment 100 may include multiple avatars (each of which can be an avatar 110) for multiple users. The avatar 110 is configured to be a virtual or graphical representation of a user. For example, a representation of a human, an animal, a machine, a robot, an artificial intelligence (AI) system, etc. In some arrangements, the avatar 110 may include a realistic representation of one or more physical features of the user (e.g., a face, eyes, a nose, ears, hair, a head shape, a body shape, a skin color, etc.). In some arrangements, the avatar 110 includes an idealized or stylized representation of the one or more physical features of the user. For example, a blurry (e.g., pixilated, cloudy, fuzzy, foggy, cartoonized, etc.) representation of the one or more physical features of the user. In some arrangements, the avatar 110 does not include any representation of the user and can be a 2D or 3D graphical representation of another object. For example, the avatar 110 may be customizable by the user, such that the user may select at least one feature or aspect of the avatar 110. In these arrangements, the avatar 110 may be a living creature (e.g., a human, a dog, a horse, an alien, etc.), an imaginary living creature (e.g., a Santa Claus, a tooth fairy, etc.), or a non-living object (e.g., a chair, a car, a house, etc.). The virtual location of the avatar 110 in the virtual environment 100 can be represented by a point defined by a set of virtual coordinates. In some arrangements, the virtual location (e.g., the virtual coordinates defining the same) can be set by the user using a user device. In some arrangements, a virtual position can be mapped to a physical position by mapping a point defined by a set of virtual coordinates in the virtual environment 100 to a point defined by a set of physical coordinates. In some arrangements, the avatar 110 may be shown to include a volume and a surface area in the virtual environment 100.

The user can control the avatar 110 and its activities within the virtual environment and view the virtual environment 100 using the user device within the physical space. In some arrangements, the user device may be one or more of a headset (e.g., an AR goggle/glasses, a VR goggle/glasses, etc.), a phone, a tablet, a motion-tracking suit, a hologram system, a haptic glove, a controller, a haptic feedback olfactory device, sensors, cameras, and so on. The user device may be configured to receive input from the user. For example, the user device may detect movement (e.g., a body gesture, a facial expression, etc.) of the user, a voice command (e.g., talking, a verbal instruction, etc.) of the user, a geographic location of the user within the physical space, or the like, as input. The user device may be configured to output feedback to the user based on the input from the user. For example, the feedback may be visually presented to the user via a display, audibly presented to the user via a speaker (e.g., headphones, earphones, television speakers, studio speakers, etc.), haptically presented to the user via an actuator (e.g., an eccentric rotating mass (ERM) actuator, a linear resonant actuator (LRA), a piezoelectric actuator, etc.), a motor, a servomotor, an air vortex ring, an ultrasound transducer, etc., olfactorily presented to the user via a scent-generating device, or gustatorily presented to the user via a taste-generating device (e.g., a taste simulator, etc.).

In some arrangements, the user device and/or a backend processor providing the virtual environment 100 are configured to determine the virtual coordinates based on the physical coordinates using transformation matrices between the physical coordinates and the virtual coordinates, such that the user may control the avatar 110 within the virtual environment 100 by interacting with the user device (e.g., moving, talking, touching, pointing, speaking, etc.) within the outlined physical space. In these arrangements, the user device and/or the backend processor may create a dynamic spatial map of the outlined physical space which is then generated as actions or movements in the virtual environment 100. For example, the user device may detect actions (e.g., a body gesture, a voice command, a facial expression, etc.) of the user within the physical space that are defined by dynamic, changing physical coordinates, defined as action physical coordinates. The action physical coordinates may include physical coordinates of a hand of the user, a finger of the user, pupils of the user, a lip of the user, a tongue of the user, and so on, relative to the physical location or another point representing the user. Using transformation matrices, the user device and/or the backend processor may transform the action physical coordinates into dynamic, changing virtual coordinates, defined as action virtual coordinates. The action virtual coordinates may be used by the user device and/or the backend processor to duplicate, mirror, imitate, simulate, trigger, translate, or convert the actions of the user in the physical space to the actions of the avatar 110 within the virtual environment 100 relative to the virtual location or another point representing the avatar 110.

In some arrangements, multiple actions of the user defined by action physical coordinates may be detected by sensors of the user device in chronological order, such that the user device detects a sequence of actions of the user in the physical space. For example, the sequence of actions of the user in the physical space may be the user clapping their hands 4times, the user jumping 7 times on one leg, the user falling down, or the like, that correspond to a pre-determined sequence of actions of the user in the physical space. Detecting a pre-determined sequence of actions of the user in the physical space that translates into a sequence of actions in the virtual environment 100 may be a trigger that initiates a pre-determined protocol in the virtual environment 100.

The virtual environment 100 may include a virtual meeting space 120 (e.g., shown as a conference room, a meeting room, a business room, etc.) displayed within the virtual environment 100. The virtual meeting space 120 is configured to provide a secure place within the virtual environment 100 for parties (e.g., users, etc.) to collaborate and communicate, such as to discuss documents or agreements (e.g., contracts, smart contracts, blockchain contracts, legal agreements, non-legal agreements, binding agreements, non-binding agreements, inheritances, instruments, etc.). The agreements may be regarding physical assets, virtual assets, virtual representations of physical assets, services, trades, inheritances, wills, trusts, and the like. The virtual meeting space 120 reduces a risk of fraud by requiring authentication of the parties before authorizing entrance of the parties into the virtual meeting space 120, improving a security of the virtual meeting space 120. Furthermore, input from the parties within the virtual meeting space 120 may be tokenized to authenticate or memorialize a discussion or an agreement made between the parties. The virtual meeting space 120 may be displayed in the virtual environment 100 in 2D or 3D. The virtual environment 100 may include multiple virtual meeting spaces 120.

In some arrangements, the virtual meeting space 120 may occupy a particular space in the virtual environment 100. The virtual meeting space 120 may include an internal space where the avatar 110 may be displayed. The internal space of the virtual meeting space 120 includes virtual coordinates within the virtual environment 100, defined as internal virtual coordinates. The internal space of the virtual meeting space 120 may be invisible to avatars other than the avatars 110 of the parties. For example, users of avatars other than the avatars 110 may not be able to view or enter the internal virtual coordinates within the virtual environment 100, as authentication is required.

The virtual meeting space 120 includes a virtual display screen 130 (e.g., a virtual display, a virtual television, a virtual monitor, etc.). The virtual display screen 130 is configured to display information (e.g., terms, clauses, sections, evidence, support, etc.) associated with the agreement in the virtual meeting space 120. The information may include texts, an audio from an audio recording associated with the agreement, a video, a digital image, or the like. The information may include one or more files having a variety of file formats (e.g., file types, file extensions, etc.). For example, the one or more files may have file formats of Microsoft Word (e.g., .doc, .docx, etc.), OpenOffice (e.g., .odt), Adobe Portable Document Format (e.g., .pdf), Rich Text Format (e.g., .rtf), plain text file (e.g., .txt), Pulse-Code Modulation (e.g., .pcm), Waveform Audio File Format (e.g., .wav), Audio Interchange File Format (e.g., aiff), MPEG-1 Audio Layer 3 (e.g., .mp3), MPEG-4 Part 14 (e.g., mp4), Advanced Audio Coding (e.g., aac), Windows Media Audio (e.g., wma), Free Lossless Audio Codec (e.g., flac), Apple Lossless Audio Codec (e.g., alac), Audio Video Interleave (e.g., avi), Adobe Flash (e.g., .flv), iTunes video file (e.g., .m4v), Apple QuickTime movie (e.g., .mov), MPEG-4 video file (e.g., .mp4), DVD Video Object (e.g., .vob), Windows Media Video (e.g., .wmv), Bitmap (e.g., .bmp), Graphic Interchange Format (e.g., .gif), Icon (e.g., .ico), Joint Photographic Experts Group (e.g., .jpg or .jpeg), Portable Network Graphics (e.g., PNG), or the like. In some arrangements, the user may upload the information to the virtual meeting space 120 via the user device or the backend processor. The information may include a plurality of portions. The virtual display screen 130 may display all of the portions of the information (e.g., all texts of a document, the entire display size of the video/image) or some but not all of the portions of the information (e.g., a page of multiple pages of a document, a paragraph of multiple paragraphs of a document, a portion of a display size of the video/image). In some arrangements, the virtual display screen 130 occupies a 2D area or a 3D volume within the virtual meeting space 120. In some arrangements, avatars 110 of the parties that are authorized to enter the virtual meeting space 120 can discuss certain portions of the information while the information is being outputted in the virtual meeting space 120 (e.g., on the virtual display screen 130). For example, agreement may have been previously reached for other portions of the information previously in the virtual meeting space 120, the virtual environment 100, and/or the physical space.

The virtual meeting space 120 may also include a plurality of miniature virtual display screens 140. The miniature virtual display screens 140 are also configured to display information associated with the agreement in the virtual meeting space 120. The virtual meeting space 120 may include a number of miniature virtual display screens 140 that is equal to a number of parties within the virtual meeting space 120. For example, the virtual meeting space 120 may include two miniature virtual display screens for the avatars 110 of two parties within the virtual meeting space 120, five miniature virtual display screens 140 for five avatars 110 of five parties within the virtual meeting space 120, and so on. Each of the miniature virtual display screens 140 may be assigned to one of the avatars 110 of the parties. Each of the miniature virtual display screens 140 may be independently controlled by the avatar 110 assigned to the miniature virtual display screen 140 via the party of the avatar 110 using the user device. Each of the miniature virtual display screens 140 may present a same portion of the information or a different portion of the information. In some arrangements, the miniature virtual display screen 140 occupies a 2D area or a 3D volume within the virtual meeting space 120.

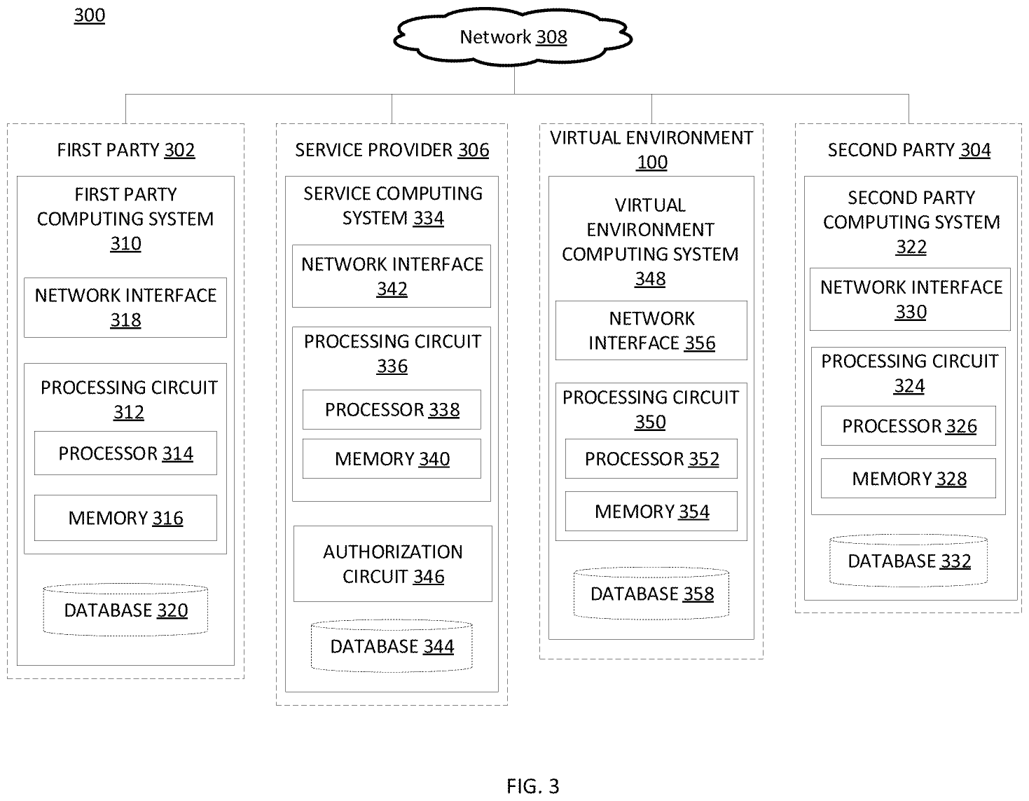

Referring to FIG. 3, a system 300 is shown according to some arrangements. As described in further detail below, the system 300 facilitates communications between a first party 302 (e.g., one of a plurality of users), a second party 304 (e.g., another one of the plurality of users), and a service provider 306 relating at least to providing the virtual meeting space 120 within the virtual environment 100. In some arrangements, the system 300 is a computing environment having one or more computing systems. In some arrangements, the system 300 is a single computing system having one or more sub-systems within. In some arrangements, the system 300 is only the single computing system. In some arrangements, the service provider 306 may be a financial institution, a management entity of the virtual environment 100, or another suitable entity. In some arrangements, the first party 302 and/or the second party 304 are the users of the information. For example, the first party 302 and the second party 304 can be parties or representatives thereto to an agreement, users, viewers, or editors of a document, video, audio, image, etc.

The system 300 includes a network 308. The network 308 may be any type or form of network. The geographical scope of the network 308 may vary widely. The network 308 may be a body area network (BAN), a personal area network (PAN), a local-area network (LAN) (e.g., Intranet, etc.), a metropolitan area network (MAN), a wide area network (WAN), or Internet. The topology of the network 308 may be of any form and may include any of the following: point-to-point, bus, star, ring, mesh, or tree. The network 308 may be an overlay network, which is virtual and sits on top of one or more layers of other networks 308. The network 308 may be of any such network topology as known to those ordinarily skilled in the art capable of supporting the operations described herein. The network 308 may utilize different techniques and layers or stacks of protocols, including an Ethernet protocol, an internet protocol suite (TCP/IP), an ATM (Asynchronous Transfer Mode) technique, an SONET (Synchronous Optical Networking) protocol, or a SDH (Synchronous Digital Hierarchy) protocol. The TCP/IP internet protocol suite may include an application layer, a transport layer, or an internet layer (including, e.g., IPv6), or the link layer. The network 308 may be a type of a broadcast network, a telecommunications network, a data communication network, or a computer network.

The system 300 includes a first party computing system 310 (e.g., a processing system, etc.), an example of which is the user device as described herein. The first party computing system 310 is configured to be utilized by the first party 302 to at least communicate with other computing systems of the system 300 via the network 308. The first party computing system 310 includes a processing circuit 312 having a processor 314 and memory 316. The processor 314 may be implemented as a general-purpose processor, an application specific integrated circuit (ASIC), one or more field programmable gate arrays (FPGAs), a digital signal processor (DSP), a group of processing components, or other suitable electronic processing components. The memory 316 includes one or more memory devices (e.g., RAM, NVRAM, ROM, Flash Memory, hard disk storage, etc.) that store data and/or computer code for facilitating the various processes described herein. Moreover, the memory 316 may be or include tangible, non-transient volatile memory or non-volatile memory. Accordingly, the memory 316 may include database components, object code components, script components, or any other type of information.

The first party computing system 310 further includes a network interface 318. The network interface 318 may link the first party computing system 310 with one or more of the network 308 and other computing systems of the system 300 by one or more communication interfaces. A communication interface can include, for example, an application programming interface (“API”) compatible with a particular component of the first party computing system 310 or the first party computing system 310. The communication interface can provide a particular communication protocol compatible with a particular component of the first party computing system 310 and a particular component/computing system of the system 300. The network interface 318 may be compatible with particular content objects, and may be compatible with particular content delivery systems corresponding to particular content objects. For example, the network interface 318 may be compatible with transmission of video content, audio content, or any combination thereof. For example, the network interface 318 may be compatible with payment processing transmissions by a protocol compatible with payment processing latency and encryption.

The first party computing system 310 further includes a database 320. The database 320 is configured to store data associated with the first party 302 and/or the first party computing system 310. The database 320 may include one or more hardware memory devices to store binary data, digital data, or the like. The database 320 may include one or more electrical components, electronic components, programmable electronic components, reprogrammable electronic components, integrated circuits, semiconductor devices, flip flops, arithmetic units, or the like. The database 320 may include at least one of a non-volatile memory device, a solid-state memory device, a flash memory device, and a NAND memory device. The database 320 may include one or more addressable memory regions disposed on one or more physical memory arrays. A physical memory array may include a NAND gate array disposed on, for example, at least one of a particular semiconductor device, integrated circuit device, and printed circuit board device. While the database 320 is shown as part of the first party computing system 310, the database 320 can be external to the first party computing system 310 and communicably coupled to the first party computing system 310 via the network 308.

The database 320 may store one or more first party identifiers associated with the first party 302. The first party identifiers are configured to include information (e.g., data, etc.) that identifies the first party 302. In some arrangements, the first party identifier may include biometric data (e.g., DNA, fingerprints, facial patterns, voice characteristics, etc.), a social media account, an account number, a decentralized identifier (DID) (e.g., a pseudo-anonymous identifier, etc.), a house address, a business address, a name, a SSN, a driver license number, an identification card number, a passport number, a transaction history, a credit score, a transaction rating based on the transaction history, a testimony about the first party 302, or the like. For example, the first party identifier may include a facial feature of the first party 302 that is detectable by a camera (e.g., a camera device, etc.) of a first user device (e.g., the user device for the first party 302), a fingerprint of the first party 302 that is detectable by a fingerprint scanner of the first user device, a voice command of the first party 302 that is detectable by a microphone of the first user device, and the like. The transaction history of the first party 302 may be recorded on a digital wallet (e.g., a virtual wallet, a blockchain wallet, a METAMASK®, a MathWallet®, an ALPHAWALLET®, a TRUST WALLET®, etc.) of the first party 302. In some arrangements, the first party identifier may include an Internet Protocol (IP) address of the first party computing system 310 or the first user device, a Media Access Control (MAC) address of the first party computing system 310 or the first user device, a serial number of the first party computing system 310 or the first user device, a device identifier of the first party computing system 310 or the first user device, a Global Positioning System (GPS) address of the first party computing system 310 or the first user device, or the like.

The system 300 further includes a second party computing system 322, an example of which is the user device as described herein. The second party computing system 322 is configured to be utilized by the second party 304 to at least communicate with other computing systems of the system 300 (e.g., the first party computing system 310, etc.) via the network 308. The second party computing system 322 includes a processing circuit 324 having a processor 326 and memory 328. Similar to the processor 314 of the first party computing system 310, the processor 326 of the second party computing system 322 may be implemented as a general-purpose processor, the ASIC, the one or more FPGAs, the DSP, the group of processing components, or other suitable electronic processing components. Similar to the memory 316 of the first party computing system 310, the memory 328 of the second party computing system 322 includes one or more memory devices that store data and/or computer code for facilitating the various processes described herein. Moreover, the memory 328 may be or include tangible, non-transient volatile memory or non-volatile memory. Accordingly, the memory 328 may include database components, object code components, script components, or any other type of information.

The second party computing system 322 further includes a network interface 330. The network interface 330 may link the second party computing system 322 with one or more of the network 308 and other computing systems of the system 300 (e.g., the first party computing system 310, etc.) by one or more communication interfaces. A communication interface can include, for example, an API compatible with a particular component of the second party computing system 322 or the second party computing system 322. The communication interface can provide a particular communication protocol compatible with a particular component of the second party computing system 322 and a particular component/computing system of the system 300. The network interface 330 may be compatible with particular content objects, and may be compatible with particular content delivery systems corresponding to particular content objects. For example, the network interface 330 may be compatible with transmission of video content, audio content, or any combination thereof. For example, the network interface 330 may be compatible with payment processing transmissions by a protocol compatible with payment processing latency and encryption.

The second party computing system 322 further includes a database 332. The database 332 is configured to store data associated with the second party 304 and/or the second party computing system 322. The database 332 may include one or more hardware memory devices to store binary data, digital data, or the like. Similar to the database 320 of the first party computing system 310, the database 332 of the second party computing system 322 may include one or more electrical components, electronic components, programmable electronic components, reprogrammable electronic components, integrated circuits, semiconductor devices, flip flops, arithmetic units, or the like. The database 332 may include at least one of a non-volatile memory device, a solid-state memory device, a flash memory device, and a NAND memory device. The database 332 may include one or more addressable memory regions disposed on one or more physical memory arrays. A physical memory array may include a NAND gate array disposed on, for example, at least one of a particular semiconductor device, integrated circuit device, and printed circuit board device. While the database 332 is shown as part of the second party computing system 322, the database 332 can be external to the second party computing system 322 and communicably coupled to the second party computing system 322 via the network 308.

The database 332 may store one or more second party identifiers associated with the second party 304. The second party identifiers are configured to include information that identifies the second party 304. In some arrangements, similar to the implementations of the first party identifiers, the second party identifier may include biometric data, the social media account, the account number, the DID, the house address, the business address, the SSN, the driver license number, the identification card number, the passport number, the transaction history, the credit score, the transaction rating based on the transaction history, a testimony about the second party 304, or the like. For example, the second party identifier may include a facial feature of the second party 304 that is detectable by a camera of a second user device (e.g., the user device for the second party 304), a fingerprint of the second party 304 that is detectable by a fingerprint scanner of the second user device, or a voice command of the second party 304 that is detectable by a microphone of the second user device. In some arrangements, the second party identifier may include an IP address of the second party computing system 322 or the second user device, a MAC address of the second party computing system 322 or the second user device, a serial number of the second party computing system 322 or the second user device, a device identifier of the second party computing system 322 or the second user device, a GPS address of the second party computing system 322 or the second user device, or the like.

The system 300 further includes a service computing system 334. The service computing system 334 is configured to be utilized by the service provider 306 to at least communicate with other computing systems of the system 300 (e.g., the first party computing system 310 and the second party computing system 322) via the network 308. The service computing system 334 may also be utilized by the virtual environment 100 to at least communicate with other computing system of the system 300. The service computing system 334 is also configured to facilitate access to at least one of the virtual environment 100 or the virtual meeting space 120 within the virtual environment 100. In some arrangements, the service computing system 334 may be, or be a part of, a blockchain, a database, a server, or the network 308. The service computing system 334 includes a processing circuit 336 having a processor 338 and memory 340. Similar to the processor 314 of the first party computing system 310 and the processor 326 of the second party computing system 322, the processor 338 of the service computing system 334 may be implemented as the general-purpose processor, the ASIC, the one or more FPGAs, the DSP, the group of processing components, or other suitable electronic processing components. Similar to the memory 316 of the first party computing system 310 and the memory 328 of the second party computing system 322, the memory 340 of the service computing system 334 includes one or more memory devices that store data and/or computer code for facilitating the various processes described herein. Moreover, the memory 340 may be or include tangible, non-transient volatile memory or non-volatile memory. Accordingly, the memory 340 may include database components, object code components, script components, or any other type of information.

The service computing system 334 further includes a network interface 342. The network interface 342 may link the service computing system 334 with one or more of the network 308 and other computing systems of the system 300 (e.g., the first party computing system 310 and the second party computing system 322) by one or more communication interfaces. The communication interface can include, for example, an API compatible with a particular component of the service computing system 334 or service computing system 334. The communication interface can provide a particular communication protocol compatible with a particular component of the service computing system 334 and a particular component/computing system of the system 300. Similar to the network interface 318 of the first party computing system 310 and the network interface 330 of the second party computing system 322, the network interface 342 of the service computing system 334 may be compatible with particular content objects, and may be compatible with particular content delivery systems corresponding to particular content objects. For example, the network interface 342 may be compatible with transmission of video content, audio content, or any combination thereof. For example, the network interface 342 may be compatible with payment processing transmissions by a protocol compatible with payment processing latency and encryption.

The service computing system 334 further includes a database 344. The database 344 is configured to store data associated with the service provider 306 and/or the service computing system 334. The database 344 may also store data associated with the virtual environment 100. Similar to the database 320 of the first party computing system 310 and the database 332 of the second party computing system 322, the database 344 of the service computing system 334 may include one or more hardware memory devices to store binary data, digital data, or the like. The database 344 may include one or more electrical components, electronic components, programmable electronic components, reprogrammable electronic components, integrated circuits, semiconductor devices, flip flops, arithmetic units, or the like. The database 344 may include at least one of the non-volatile memory device, the solid-state memory device, the flash memory device, and the NAND memory device. The database 344 may include one or more addressable memory regions disposed on one or more physical memory arrays. A physical memory array may include a NAND gate array disposed on, for example, at least one of a particular semiconductor device, integrated circuit device, and printed circuit board device.

The database 344 may store one or more recorded first party identifiers associated with the first party 302 and one or more recorded second party identifiers associated with the second party 304. The recorded first party identifiers are configured to include information that identifies the first party 302 and the recorded second party identifiers are configured to include information that identifies the second party 304. The recorded first party identifiers may include implementations similar to the first party identifier stored in the database 320 of the first party computing system 310. The recorded second party identifiers may include implementations similar to the second party identifier stored in the database 332 of the second party computing system 322.

The service computing system 334 further includes an authorization circuit 346. The authorization circuit 346 is configured to authorize (e.g., approve, permit, allow, etc.) the first party 302 to enter the virtual meeting space 120. The authorization circuit 346 performs this authorization by receiving the first party identifier from the first party computing system 310 over the network 308 and comparing the first party identifier with the recorded first party identifier. In response to determining that the first party identifier matches the recorded first party identifier, the authorization circuit 346 transmits a positive authorization (e.g., matching, etc.) value to the processing circuit 336 of the service computing system 334, thus permitting entrance of a first party avatar (e.g., the avatar 110 of the first party 302) into the virtual meeting space 120. In some arrangements, the authorization circuit 346 will provide a negative authorization value to the processing circuit 336 of the service computing system 334, in response to determining that the first party identifier does not match the recorded first party identifier, thus denying entrance of the first party avatar into the virtual meeting space 120. The authorization circuit 346 is further configured to authorize the second party 304 to enter the virtual meeting space 120. The authorization circuit 346 performs this authorization by receiving the second party identifier from the second party computing system 322 over the network 308 and comparing the second party identifier with the recorded second party identifier. In response to determining that the second party identifier matches the recorded second party identifier, the authorization circuit 346 transmits a positive authorization value to the processing circuit 336 of the service computing system 334, thus permitting entrance of a second party avatar (e.g., the avatar 110 of the second party 304) into the virtual meeting space 120. In some arrangements, the authorization circuit 346 will provide a negative authorization value to the processing circuit 336 of the service computing system 334, in response to determining that the second party identifier does not match the recorded second party identifier, thus denying entrance of the second party avatar into the virtual meeting space 120. In some arrangements, the authorization circuit 346 is configured to receive multiple first party identifiers from the first party computing system 310 and compare the multiple first party identifiers with multiple recorded first party identifiers. Similarly, the authorization circuit 346 may be configured to receive multiple second party identifiers from the second party computing system 322 and compare the multiple second party identifiers with multiple recorded second party identifiers.

In some arrangements, the service computing system 334 generates the virtual environment 100 and makes the virtual environment 100 accessible to the first party computing system 310 and the second party computing system 322 via the network 308. The service computing system 334 may store, a part of or the entirety of, the data defining the virtual environment 100 in the database 344. The processing circuit 336 of the service computing system 334 may facilitate changes (e.g., additions, deletions, removals, movement, etc.) to the virtual environment 100. In some arrangements, the service computing system 334 may authorize the first party computing system 310 and the second party computing system 322 to make changes to the virtual environment 100. In some arrangements, the first party computing system 310 and the second party computing system 322 communicate changes of the virtual environment 100 to the service computing system 334, where the processing circuit 336 makes the changes of the first party computing system 310 and the second party computing system 322 to the virtual environment 100. In some arrangements, the virtual environment 100 is stored in a network database, where the network database is one or more of the databases 320, 332, and 344.

The system 300 further includes a virtual environment computing system 348. The virtual environment computing system 348 is configured to be utilized by the virtual environment 100 to at least communicate with other computing systems of the system 300 (e.g., the first party computing system 310, the second party computing system 322, and the service computing system 334) via the network 308. The virtual environment computing system 348 may generate the virtual environment 100 and make the virtual environment 100 accessible to the first party computing system 310, the second party computing system 322, and the service computing system 334 via the network 308.

In some arrangements, the virtual environment computing system 348 may be, or be a part of, the blockchain, a database, a server, or the network 308. The virtual environment computing system 348 includes a processing circuit 350 having a processor 352 and memory 354. The processing circuit 350 may facilitate changes to the virtual environment 100. In some arrangements, the virtual environment computing system 348 may authorize the first party computing system 310, the second party computing system 322, and/or the service computing system 334 to make changes to the virtual environment 100. In some arrangements, the first party computing system 310, the second party computing system 322, and the service computing system 334 communicate changes of the virtual environment 100 to the virtual environment computing system 348, where the processing circuit 350 makes the changes of the first party computing system 310, the second party computing system 322, and the service computing system 334 to the virtual environment 100. Similar to the processor 314 of the first party computing system 310, the processor 326 of the second party computing system 322, and the processor 338 of the service computing system 334, the processor 352 of the virtual environment computing system 348 may be implemented as the general-purpose processor, the ASIC, the one or more FPGAs, the DSP, the group of processing components, or other suitable electronic processing components. Similar to the memory 316 of the first party computing system 310, the memory 328 of the second party computing system 322, and the memory 340 of the service computing system 334, the memory 354 of the virtual environment computing system 348 includes one or more memory devices that store data and/or computer code for facilitating the various processes described herein. Moreover, the memory 354 may be or include tangible, non-transient volatile memory or non-volatile memory. Accordingly, the memory 354 may include database components, object code components, script components, or any other type of information.

The virtual environment computing system 348 further includes a network interface 356. The network interface 356 may link the virtual environment computing system 348 with one or more of the network 308 and other computing systems of the system 300 (e.g., the first party computing system 310, the second party computing system 322, and the service computing system 334) by one or more communication interfaces. The communication interface can include, for example, an API compatible with a particular component of the virtual environment computing system 348 or the virtual environment computing system 348. The communication interface can provide a particular communication protocol compatible with a particular component of the virtual environment computing system 348 and a particular component/computing system of the system 300. Similar to the network interface 318 of the first party computing system 310, the network interface 330 of the second party computing system 322, and the network interface 342 of the service computing system 334, the network interface 356 of the virtual environment computing system 348 may be compatible with particular content objects, and may be compatible with particular content delivery systems corresponding to particular content objects. For example, the network interface 356 may be compatible with transmission of video content, audio content, or any combination thereof. For example, the network interface 356 may be compatible with payment processing transmissions by a protocol compatible with payment processing latency and encryption.

The virtual environment computing system 348 further includes a database 358. The database 358 is configured to store data associated with or defining the virtual environment 100 and/or the virtual environment computing system 348. Similar to the database 320 of the first party computing system 310, the database 332 of the second party computing system 322, and the database 344 of the service computing system 334, the database 358 of the virtual environment computing system 348 may include one or more hardware memory devices to store binary data, digital data, or the like. The database 358 may include one or more electrical components, electronic components, programmable electronic components, reprogrammable electronic components, integrated circuits, semiconductor devices, flip flops, arithmetic units, or the like. The database 358 may include at least one of the non-volatile memory device, the solid-state memory device, the flash memory device, and the NAND memory device. The database 358 may include one or more addressable memory regions disposed on one or more physical memory arrays. A physical memory array may include a NAND gate array disposed on, for example, at least one of a particular semiconductor device, integrated circuit device, and printed circuit board device. In some arrangements, the database 358 may store the one or more recorded first party identifiers associated with the first party 302 and the one or more recorded second party identifiers associated with the second party 304. In some arrangements, the virtual environment computing system 348 may include an authorization circuit similar in implementation and function to the authorization circuit 346 of the service computing system 334.

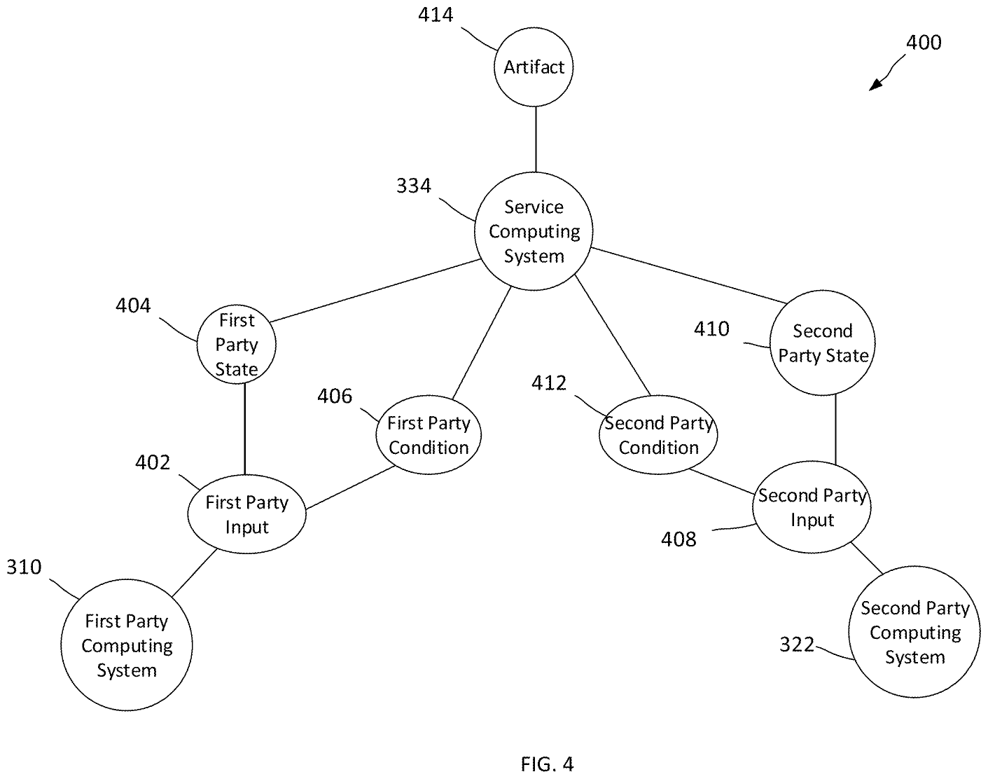

Referring to FIG. 4, a communications diagram 400 of the system 300 is shown, according to some arrangements. Communications from the first party computing system 310, via the first party 302, include a first party input 402 (e.g., input from the first party 302). The first party input 402 may include a first party state 404 (e.g., a state of the first party 302) and a first party condition 406 (e.g., a condition of the first party 302). Communications from the second party computing system 322, via the second party 304, include a second party input 408 (e.g., input from the second party 304). The second party input 408 may include a second party state 410 (e.g., a state of the second party 304) and a second party condition 412 (e.g., a condition of the second party 304). Communications from the service computing system 334, via the service provider 306, may include an artifact 414.

In some arrangements, the database 344 of the service computing system 334 may store one or more recorded first party inputs associated with the first party 302 and one or more recorded second party inputs associated with the second party 304. The recorded first party inputs may be configured to identify the first party 302 using the first party input 402 and the recorded second party inputs may be configured to identify the second party 304 using the second party input 408. The recorded first party input may include implementations similar to the first party input 402 detected by the first party computing system 310 or the first user device. The recorded second party input may include implementations similar to the second party input 408 detected by the second party computing system 322 or the second user device.

In some arrangements, in addition to the authorization circuit 346 being configured to receive the first party identifier from the first party computing system 310 and compare the first party identifier with the recorded first party identifier, the authorization circuit 346 is also configured to receive the first party input 402 and compare the first party input 402 to the recorded first party input. For example, in response to determining that (i) the first party identifier matches the recorded first party identifier and (ii) the first party input 402 matches the recorded first party input, the authorization circuit 346 transmits the positive authorization value to the processing circuit 336 of the service computing system 334, thus permitting entrance of the first party avatar into the virtual meeting space 120. In some arrangements, the authorization circuit 346 will provide the negative authorization value to the processing circuit 336 of the service computing system 334, in response to determining that (i) the first party identifier does not match the recorded first party identifier or (ii) the first party input 402 does not match the recorded first party input, thus denying entrance of the first party avatar into the virtual meeting space 120.

Similarly, in addition to the authorization circuit 346 being configured to receive the second party identifier from the second party computing system 322 and compare the second party identifier with the recorded second party identifier, the authorization circuit 346 may also be configured to receive the second party input 408 and compare the second party input 408 to the recorded second party input. For example, in response to determining that (i) the second party identifier matches the recorded second party identifier and (ii) the second party input 408 matches the recorded second party input, the authorization circuit 346 transmits the positive authorization value to the processing circuit 336 of the service computing system 334, thus permitting entrance of the second party avatar into the virtual meeting space 120. In some arrangements, the authorization circuit 346 will provide the negative authorization value to the processing circuit 336 of the service computing system 334, in response to determining that (i) the second party identifier does not match the recorded second party identifier or (ii) the second party input 408 does not match the recorded second party input, thus denying entrance of the second party avatar into the virtual meeting space 120.

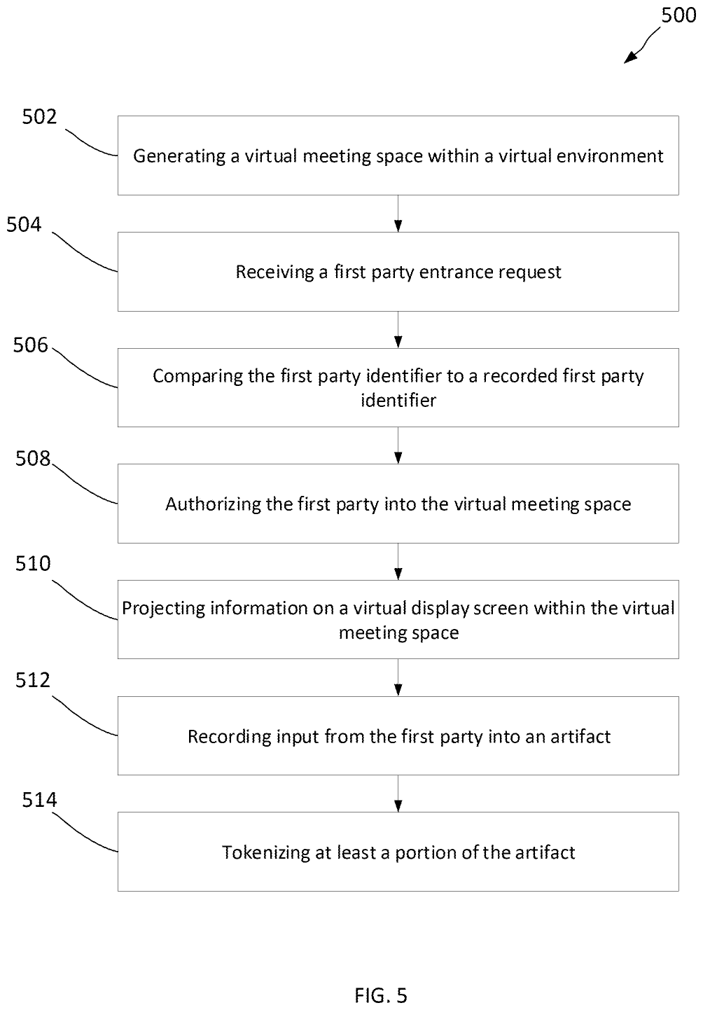

Referring to FIG. 5, a flow diagram of a method 500 for facilitating a meeting in a virtual meeting space (e.g., the virtual meeting space 120) is shown, according to some arrangements. The method 500 may be conducted by the service computing system 334. As shown, at 502, the service computing system 334 generates the virtual meeting space 120 within the virtual environment 100. The service computing system 334 may define (e.g., allocate, etc.) and host the virtual coordinates of the virtual meeting space 120 in the virtual environment 100. In some arrangements, the service computing system 334 may store a recorded configuration of the virtual meeting space 120 in the database 344. In some arrangements, the first party computing system 310 and/or the second party computing system 322 may store the recorded configuration of the virtual meeting space 120 in the database 320 of the first party computing system 310 or the database 332 of the second party computing system 322.

At 502, the service computing system 334 may utilize the recorded configuration of the virtual meeting space 120 to generate the virtual meeting space 120 within the virtual environment 100. In some arrangements, the service computing system 334 may receive a meeting space generation request to generate the virtual meeting space 120 from the first party 302 via the first party computing system 310 or the first user device or the second party 304 via the second party computing system 322 or the second user device. The meeting space generation request my include at least one of a meeting time in the virtual meeting space 120, a name of the first party 302, a name of the second party 304, the first party identifier, the second party identifier, a purpose of meeting in the virtual meeting space 120, a type/category of the agreement, a market value of the agreement, or a time length of the agreement.

The service computing system 334 may utilize parts of the meeting space generation request to define the virtual coordinates of the virtual meeting space 120 in the virtual environment 100. In some arrangements, the purpose of meeting may correspond to a location in the virtual environment 100. For example, in response to determining that the purpose of meeting in the virtual meeting space 120 is associated with a virtual asset, the service computing system 334 may define the virtual coordinates of the virtual meeting space 120 proximate to or on the virtual coordinates of the virtual asset in the virtual environment 100. In some arrangements, the market value of the agreement may correspond to another location in the virtual environment 100. For example, in response to determining the market value of the agreement is high, the service computing system 334 may define the virtual coordinates of the virtual meeting space 120 proximate to or on virtual coordinates of a secure location in the virtual environment 100. The secure location may be proximate to or within virtual coordinates of a police station or a financial institution in the virtual environment 100.

At 504, the service computing system 334 receives a first party entrance request to enter into the virtual meeting space 120 from the first party 302 via the first party computing system 310. The service computing system 334 may receive the first party entrance request via the network 308. The first party entrance request may include a first party authentication token. The first party authentication token may include the first party identifier.

At 506, the service computing system 334 authenticates the first party 302. In some arrangements, the service computing system 334 compares the first party identifier to the recorded first party identifier. The service computing system 334 retrieves the first party identifier from the first party entrance request and the recorded first party identifier from the database 344. In some arrangements, comparison between the first party identifier and the recorded first party identifier may include a pre-determined tolerance. The pre-determined tolerance may be dependent on a type of the first party identifier and the recorded first party identifier. For example, in response to the service computing system 334 determining that the first party identifier and the recorded first party identifier are a full name type of the first party 302, the pre-determined tolerance may be an existence or a lack of a middle name, where “John Smith” of the first party identifier matches “John Frank Smith” of the recorded first party identifier. In some arrangements, the comparison between the first party identifier and the recorded first party identifier does not include the pre-determined tolerance. In some arrangements, the service computing system 334 performs authentication of the first party 302 by verifying password information, username information, biometric data, and/or the like from the first party 302.

At 508, based on the first party identifier matching the recorded first party identifier, the service computing system 334 authorizes the first party avatar into the virtual meeting space 120. Prior to 508, the virtual meeting space 120 may have been invisible or unavailable to the first party 302 of the first party avatar. For example, the service computing system 334 may have configured the virtual coordinates of the virtual meeting space 120 to be invisible (e.g., blurry, blacked-out, etc.) to the first party avatar. The service computing system 334 may have also configured the virtual coordinates of the virtual meeting space 120 to be inaccessible by the first party avatar, where the service computing system 334 prevents the virtual coordinates of the first party avatar to come within (e.g., enter, etc.) the virtual coordinates of the virtual meeting space 120. At 508, the service computing system 334 may make the virtual coordinates of the virtual meeting space 120 visible and accessible to the first party 302 of the first party avatar. For example, the service computing system 334 may configure the virtual coordinates of the virtual meeting space 120 to be visible (e.g., displayable, etc.) to the first party avatar. The service computing system 334 may also configure the virtual coordinates of the virtual meeting space 120 to be accessible by the first party avatar, where the service computing system 334 authorizes the virtual coordinates of the first party avatar to come within the virtual coordinates of the virtual meeting space 120.

At 510, in response to authorizing the first party 302 into the virtual meeting space 120, the service computing system 334 projects the information on the virtual display screen 130 within the virtual meeting space 120. The service computing system 334 may receive the information in any file format from the first party computing system 310 or the second party computing system 322 and convert the information file to be displayed on the virtual display screen 130. For example, the service computing system 334 may receive the information of the agreement from the database 320 via the first party computing system 310 or the database 332 via the second party computing system 322, load the information from the database 320 or the database 332 to the virtual meeting space 120, and project the information on the virtual display screen 130. The service computing system 334 may also retrieve the information in any file format from the database 344 of the service computing system 334 and convert the information file to be displayed on the virtual display screen 130. For example, the service computing system 334 may load the information from the database 344 to the virtual meeting space 120 and project the information on the virtual display screen 130. In some arrangements, a third-party computing system in communication with the network 308 may have the information of the agreement stored in a third-party database. For example, the service computing system 334 may receive the information of the agreement from the third-party database via the third-party computing system, load the information from the third-party database to the virtual meeting space 120, and project the information on the virtual display screen 130.

At 512, the service computing system 334 records the first party input 402 within the virtual meeting space 120 into the artifact 414 using the first user device or the first party computing system 310, while the information is projected on the virtual display screen 130. The first party input 402 may include a sound from the first party 302, a video from the first party 302, a body gesture of the first party 302, a face gesture of the first party 302, an eye gesture of the first party 302, or the like. The first party input 402 may be detected by the first user device. For example, the sound from the first party 302 may be detected by a microphone of the first user device, the video of the first party 302 may be detected by a camera of the first user device, and the body gesture, the face gesture, and the eye gesture of the first party 302 may be detected by one or more sensors of the first user device. In some arrangements, the first party input 402 corresponds to consent of the first party 302 to at least one portion of the information projected on the virtual display screen 130.

At 514, the service computing system 334 tokenizes at least a portion of the artifact 414. The service computing system 334 may store the artifact 414 in the database 344 and generate a link (e.g., a Uniform Resource Locator (URL), a Uniform Resource Identifier (URI), etc.) to the artifact 414. The link to the artifact 414 identifies where the artifact 414 is stored. In some arrangements, tokenizing the portion of the artifact 414 includes the service computing system 334 minting a Non-Fungible Token (NFT). The NFT includes metadata that may include the link to the artifact 414.

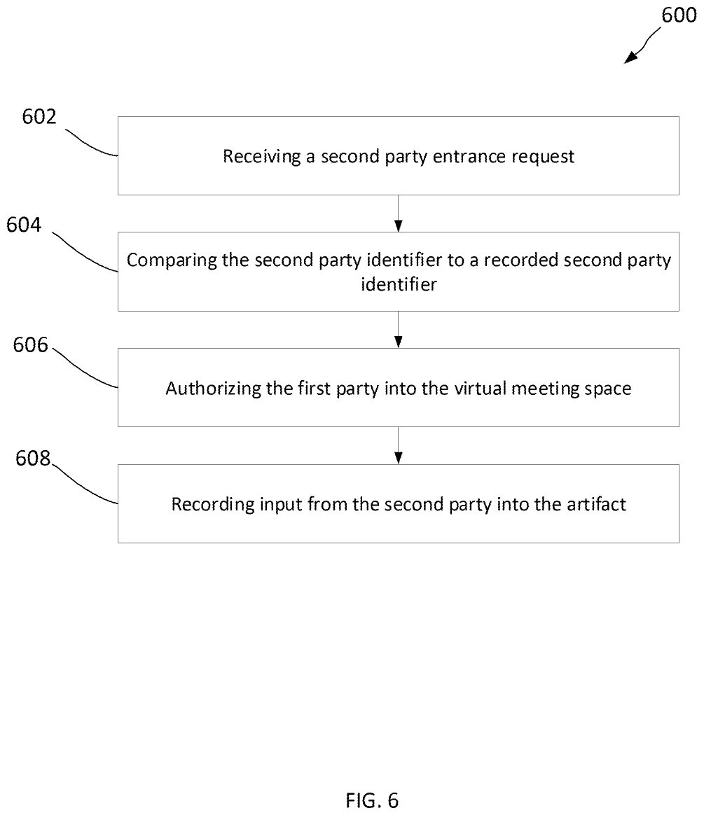

Referring to FIG. 6, a flow diagram of a method 600 for processing a second party entrance request is shown, according to some arrangements. The method 600 may be conducted by the service computing system 334. As shown, at 602, the service computing system 334 receives a second party entrance request to enter into the virtual meeting space 120 from the second party 304 via the second party computing system 322. Similar to implementations of the first party entrance request, the service computing system 334 may receive the second party entrance request via the network 308. The second party entrance request may include a second party authentication token. The second party authentication token may include the second party identifier.

At 604, the service computing system 334 authenticates the second party 304. In some arrangements, the service computing system 334 compares the second party identifier to the recorded second party identifier. The service computing system 334 retrieves the second party identifier from the second party entrance request and the recorded second party identifier from the database 344. In some arrangements, comparison between the second party identifier and the recorded second party identifier may include the pre-determined tolerance as described in the comparison between the first party identifier and the recorded first party identifier. In some arrangements, the comparison between the second party identifier and the recorded second party identifier does not include the pre-determined tolerance. In some arrangements, the service computing system 334 performs authentication of the second party 304 by verifying password information, username information, biometric data, and/or the like from the second party 304.

At 606, based on the second party identifier matching the recorded second party identifier, the service computing system 334 authorizes the second party avatar into the virtual meeting space 120. Prior to 606, the virtual meeting space 120 may have been invisible or unavailable to the second party 304 of the second party avatar. For example, the service computing system 334 may have configured the virtual coordinates of the virtual meeting space 120 to be invisible to the second party avatar. The service computing system 334 may have also configured the virtual coordinates of the virtual meeting space 120 to be inaccessible by the second party avatar, where the service computing system 334 prevents the virtual coordinates of the second party avatar to come within the virtual coordinates of the virtual meeting space 120. At 606, the service computing system 334 may make the virtual coordinates of the virtual meeting space 120 visible and accessible to the second party 304 of the second party avatar. For example, the service computing system 334 may configure the virtual coordinates of the virtual meeting space 120 to be visible to the second party avatar. The service computing system 334 may also configure the virtual coordinates of the virtual meeting space 120 to be accessible by the second party avatar, where the service computing system 334 authorizes the virtual coordinates of the second party avatar to come within the virtual coordinates of the virtual meeting space 120.

At 608, the service computing system 334 records the second party input 408 within the virtual meeting space 120 into the artifact 414 using the second user device or the second party computing system 322, while the information is projected on the virtual display screen 130. The second party input 408 may have similar implementations to the first party input 402. For example, the second party input 408 may include a sound from the second party 304, a video from the second party 304, a body gesture of the second party 304, a face gesture of the second party 304, an eye gesture of the second party 304, typing from the second party 304 using the second user device, clicking of the second party 304 using the second user device, or the like. The second party input 408 may be detected by the second user device. For example, the sound from the second party 304 may be detected by a microphone of the second user device, the video of the second party 304 may be detected by a camera of the second user device, and the body gesture, the face gesture, and the eye gesture of the second party 304 may be detected by one or more sensors of the second user device, typing from the second party 304 may be detected by a keyboard of the second user device, clicking from the second party 304 may be detected by a touchscreen of the second user device, and the like. In some arrangements, the second party input 408 corresponds to consent of the second party 304 to at least one portion of the information projected on the virtual display screen 130.

In some arrangements, the service computing system 334 may evaluate the first party 302, the second party 304, and/or the agreement. The evaluation may include a review of one or more of a background check of the first party 302 and/or the second party 304, a credit score of the first party 302 and/or the second party 304, an occupation of the first party 302 and/or the second party 304, an income of the first party 302 and/or the second party 304, a house address of the first party 302 and/or the second party 304, or a business address of the first party 302 and/or the second party 304. For the agreement, the evaluation may include a review of one or more of a market value of the agreement, a storage medium of the agreement, a popularity (e.g., social media popularity, etc.) of the agreement, a benefit of accepting the agreement, a privilege of taking part in the agreement, or a feature of being part of the agreement.

The service computing system 334 may set a threshold for each category on which the first party 302, the second party 304, and/or the agreement are evaluated on. In some arrangements, the first party 302, the second party 304, and the agreement must be above all thresholds set by the service computing system 334 for the evaluation. In some arrangements, the first party 302, the second party 304, and the agreement must be above at least some (e.g., one or more) of all thresholds set by the service computing system 334 for the evaluation. In some arrangements, one of the first party 302, the second party 304, and the agreement must be above all thresholds set by the service computing system 334 for the evaluation. In some arrangements, one of the first party 302, the second party 304, and the agreement must be above at least some (e.g., one or more) of all thresholds set by the service computing system 334 for the evaluation. In these arrangements, in response to determining that the first party 302, the second party 304, and/or the agreement do not meet requirements set by the evaluation of the service computing system 334, as discussed above, the service computing system 334 may deny the first party entrance request and/or the second party entrance request and terminate a remainder of the method 500 and/or the method 600.

In some arrangements, the recorded first party input and the recorded second party input may be dependent on characteristics (e.g., market value, popularity, etc.) of the agreement, such that there is a positive linear relationship between an effort (e.g., processing time, time until completed, etc.) of a recorded input (e.g., the recorded first party input and the recorded second party input) and the market value of the agreement. For example, the recorded first party input and the recorded second party input for the agreement having a market value of X may be waving of a hand in the physical space of the first party 302, detected by the first user device, and the second party 304, detected by the second user device. The recorded first party input and the recorded second party input for the agreement having a market value of Y may be the first party 302, detected by the first user device, and the second party 304, detected by the second user device, jumping 5 times in the physical space. The recorded first party input and the recorded second party input for the agreement having a market value of Z may be the first party 302, detected by the first user device, and the second party 304, detected by the second user device, meeting in the outlined physical space. The market values of the agreements may be X<Y<Z, such that a higher market value of the agreement requires higher effort of the recorded input.

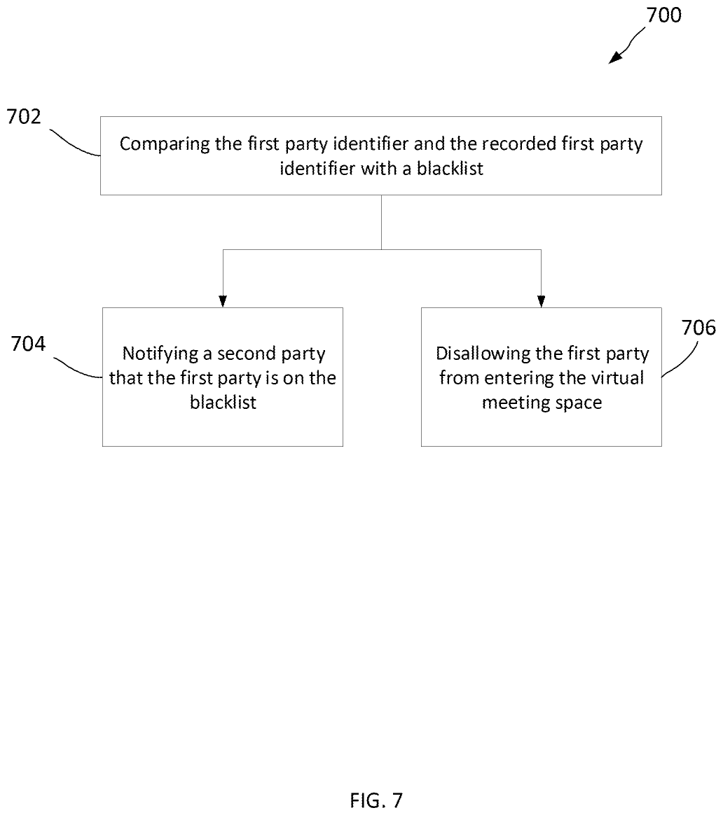

Referring to FIG. 7, a flow diagram of a method 700 for evaluating the first party 302 with a blacklist is shown, according to some arrangements. The method 700 may be conducted by the service computing system 334. As shown, at 702, the service computing system 334 compares the first party identifier and the recorded first party identifier with the blacklist. The blacklist includes a plurality of blacklisted identifiers associated with fraudulent parties having fraudulent transaction histories. The plurality of blacklisted identifiers may also be associated with parties on a travel watch/ban list identifying parties and/or individuals who are not allowed to travel and/or fly. In some arrangements, the blacklist is stored in the service computing system 334 and is updated (e.g., maintained, etc.) by the service computing system 334 or multiple service computing systems 334.

In some arrangements, a party (e.g., the first party 302 and/or the second party 304) may have a blacklisted identifier of the plurality of blacklisted identifiers based on actions of the party in the physical space. For example, the user device of the party may detect a location of the party in the physical space using a location of the user device in the physical space. The location of the party in the physical space, having physical coordinates within the physical space defined as party physical coordinates, may have been identified by the service computing system 334 via the user device. The service computing system 334 may define physical coordinates of a fraudulent location in the physical space as fraudulent physical coordinates. In some arrangements, the fraudulent location may be a city, a state, an unsafe neighborhood (e.g., a dangerous neighborhood, etc.), a crime scene, a robbery scene, or the like in the physical space. In response to determining that the party physical coordinates are within the fraudulent physical coordinates, by determining the physical coordinates of the user device are within the fraudulent physical coordinates, the service computing system 334 may blacklist the party by adding the party identifier of the party to the plurality of blacklisted identifiers.

In some arrangements, the party may have the blacklisted identifier of the plurality of blacklisted identifiers based on actions of the party in the virtual environment 100. For example, the user device of the party may detect a location of the avatar 110 of the party in the virtual environment 100 using virtual coordinates of the avatar 110 in the virtual environment 100. The location of the avatar 110 in the virtual environment 100 may have been identified by the service computing system 334 via the user device. The service computing system 334 may define virtual coordinates of a fraudulent location in the virtual environment 100 as fraudulent virtual coordinates. In some arrangements, the fraudulent location may be a city, a state, an unsafe neighborhood, a crime scene, a robbery scene, or the like in the virtual environment 100. In response to determining that the virtual coordinates of the avatar 110 are within the fraudulent virtual coordinates, the service computing system 334 may blacklist the party by adding the party identifier of the party to the plurality of blacklisted identifiers.

Based on the first party identifier and the recorded first party identifier matching one or more of the plurality of blacklisted identifiers, the service computing system 334 may execute 704 and/or 706. At 704, the service computing system 334 notifies the second party 304, via the second party computing system 322 or the second user device, that the first party 302 is on the blacklist. The service computing system 334 may notify the second party 304 that the first party 302 is on the blacklist (i) prior to the second party avatar entering the virtual meeting space 120, (ii) after the second party avatar enters the virtual meeting space 120, (iii) prior to the second party avatar making a decision on the agreement in the virtual meeting space 120, or (iv) after the second party avatar makes the decision on the agreement in the virtual meeting space 120. The service computing system 334 may provide the second party 304 with the first party identifier, the recorded first party identifier, and/or the matching one or more of the plurality of blacklisted identifiers. The second party 304, via the second party computing system 322 or the second user device, may elect to still meet with the first party avatar of the first party 302 in the virtual meeting space 120 despite the first party 302 being identified on the blacklist.

At 706, the service computing system 334 disallows (e.g., prevents, etc.) the first party avatar from entering the virtual meeting space 120 via the first party computing system 310 or the first user device. The service computing system 334 may configure the virtual coordinates of the virtual meeting space 120 to be invisible to the first party avatar. The service computing system 334 may also configure the virtual coordinates of the virtual meeting space 120 to be inaccessible by the first party avatar, preventing the virtual coordinates of the first party avatar to come within the virtual coordinates of the virtual meeting space 120.

In some arrangements, the method 700 for evaluating the first party 302 with the blacklist may be used for evaluating the second party 304 with the blacklist. For example, the service computing system 334 may compare the second party identifier and the recorded second party identifier with the blacklist. Based on the second party identifier and the recorded second party identifier matching one or more of the plurality of blacklisted identifiers, the service computing system 334 may (i) notify the first party 302, via the first party computing system 310 or the first user device, that the second party 304 is on the blacklist, and/or (ii) disallow the second party avatar from entering the virtual meeting space 120 via the second party computing system 322 or the second user device. The service computing system 334 may notify the first party 302 that the second party 304 is on the blacklist (i) prior to the first party avatar entering the virtual meeting space 120, (ii) after the first party avatar enters the virtual meeting space 120, (iii) prior to the first party avatar making a decision on the agreement in the virtual meeting space 120, or (iv) after the first party avatar makes the decision on the agreement in the virtual meeting space 120. The service computing system 334 may provide the first party 302 with the second party identifier, the recorded second party identifier, and/or the matching one or more of the plurality of blacklisted identifiers. The first party 302, via the first party computing system 310 or the first user device, may elect to still meet with the second party avatar of the second party 304 in the virtual meeting space 120 despite the second party 304 being identified on the blacklist. The service computing system 334 may configure the virtual coordinates of the virtual meeting space 120 to be invisible to the second party avatar. The service computing system 334 may also configure the virtual coordinates of the virtual meeting space 120 to be inaccessible by the second party avatar, preventing the virtual coordinates of the second party avatar to come within the virtual coordinates of the virtual meeting space 120.

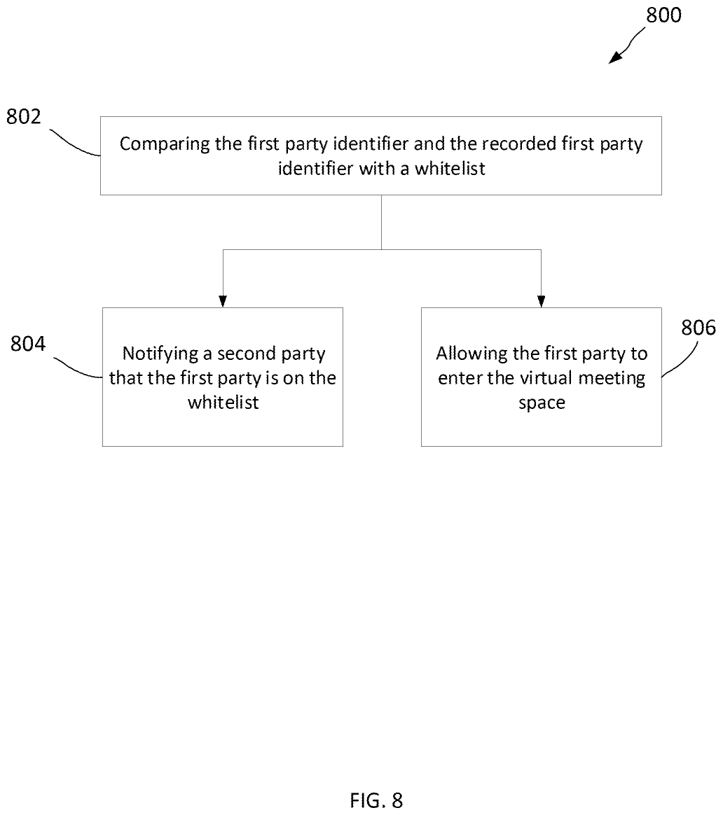

Referring to FIG. 8, a flow diagram of a method 800 for evaluating the first party 302 with a whitelist is shown, according to some arrangements. The method 800 may be conducted by the service computing system 334. As shown, at 802, the service computing system 334 compares the first party identifier and the recorded first party identifier with the whitelist. The whitelist includes a plurality of whitelisted identifiers associated with trusted parties having positive (e.g., non-fraudulent, etc.) transaction histories. In some arrangements, the whitelist is stored in the service computing system 334 and is updated by the service computing system 334 or multiple service computing systems 334.

In some arrangements, the party (e.g., the first party 302 and/or the second party 304) may have a whitelisted identifier of the plurality of whitelisted identifiers based on actions of the party in the physical space. For example, the user device of the party may detect a location of the party in the physical space using a location of the user device in the physical space. The location of the party in the physical space, having physical coordinates within the physical space defined as party physical coordinates, may have been identified by the service computing system 334 via the user device. The service computing system 334 may define physical coordinates of a trusted location in the physical space as trusted physical coordinates. In some arrangements, the trusted location may be a city, a state, a safe neighborhood (e.g., a non-dangerous neighborhood, etc.), a bank, a police station, or the like in the physical space. In response to determining that the party physical coordinates are within the trusted physical coordinates, by determining the physical coordinates of the user device are within the trusted physical coordinates, the service computing system 334 may whitelist the party by adding the party identifier of the party to the plurality of whitelisted identifiers.

In some arrangements, the party may have the whitelisted identifier of the plurality of whitelisted identifiers based on actions of the party in the virtual environment 100. For example, the user device of the party may detect a location of the avatar 110 of the party in the virtual environment 100 using virtual coordinates of the avatar 110 in the virtual environment 100. The location of the avatar 110 in the virtual environment 100 may have been identified by the service computing system 334 via the user device. The service computing system 334 may define virtual coordinates of a trusted location in the virtual environment 100 as trusted virtual coordinates. In some arrangements, the trusted location may be a city, a state, a safe neighborhood, a bank, a police station, or the like in the virtual environment 100. In response to determining that the virtual coordinates of the avatar 110 are within the trusted virtual coordinates, the service computing system 334 may whitelist the party by adding the party identifier of the party to the plurality of whitelisted identifiers.

Based on the first party identifier and the recorded first party identifier matching one or more of the plurality of whitelisted identifiers, the service computing system 334 may execute 804 and/or 806. At 804, the service computing system 334 notifies the second party 304, via the second party computing system 322 or the second user device, that the first party 302 is on the whitelist. The service computing system 334 may notify the second party 304 that the first party 302 is on the whitelist (i) prior to the second party avatar entering the virtual meeting space 120, (ii) after the second party avatar enters the virtual meeting space 120, (iii) prior to the second party avatar making the decision on the agreement in the virtual meeting space 120, or (iv) after the second party avatar makes the decision on the agreement in the virtual meeting space 120. The service computing system 334 may provide the second party 304 with the first party identifier, the recorded first party identifier, and/or the matching one or more of the plurality of whitelisted identifiers. The second party 304, via the second party computing system 322 or the second user device, may elect to not meet with the first party avatar of the first party 302 in the virtual meeting space 120 despite the first party 302 being identified on the whitelist.

At 806, the service computing system 334 allows (e.g., permits, etc.) the first party avatar to enter the virtual meeting space 120 via the first party computing system 310 or the first user device. The service computing system 334 may configure the virtual coordinates of the virtual meeting space 120 to become visible to the first party avatar. The service computing system 334 may also configure the virtual coordinates of the virtual meeting space 120 to be accessible by the first party avatar, authorizing the virtual coordinates of the first party avatar to come within the virtual coordinates of the virtual meeting space 120.

In some arrangements, the method 800 for evaluating the first party 302 with the whitelist may be used for evaluating the second party 304 with the whitelist. For example, the service computing system 334 may compare the second party identifier and the recorded second party identifier with the whitelist. Based on the second party identifier and the recorded second party identifier matching one or more of the plurality of whitelisted identifiers, the service computing system 334 may (i) notify the first party 302, via the first party computing system 310 or the first user device, that the second party 304 is on the whitelist, and/or (ii) allow the second party avatar to enter the virtual meeting space 120 via the second party computing system 322 or the second user device. The service computing system 334 may notify the first party 302 that the second party 304 is on the whitelist (i) prior to the first party avatar entering the virtual meeting space 120, (ii) after the first party avatar enters the virtual meeting space 120, (iii) prior to the first party avatar making the decision on the agreement in the virtual meeting space 120, (iv) or after the first party avatar makes the decision on the agreement in the virtual meeting space 120. The service computing system 334 may provide the first party 302 with the second party identifier, the recorded second party identifier, and/or the matching one or more of the plurality of whitelisted identifiers. The first party 302, via the first party computing system 310 or the first user device, may elect to not meet with the second party avatar of the second party 304 in the virtual meeting space 120 despite the second party 304 being identified on the whitelist. The service computing system 334 may configure the virtual coordinates of the virtual meeting space 120 to become visible to the second party avatar. The service computing system 334 may also configure the virtual coordinates of the virtual meeting space 120 to be accessible by the second party avatar, authorizing the virtual coordinates of the second party avatar to come within the virtual coordinates of the virtual meeting space 120.

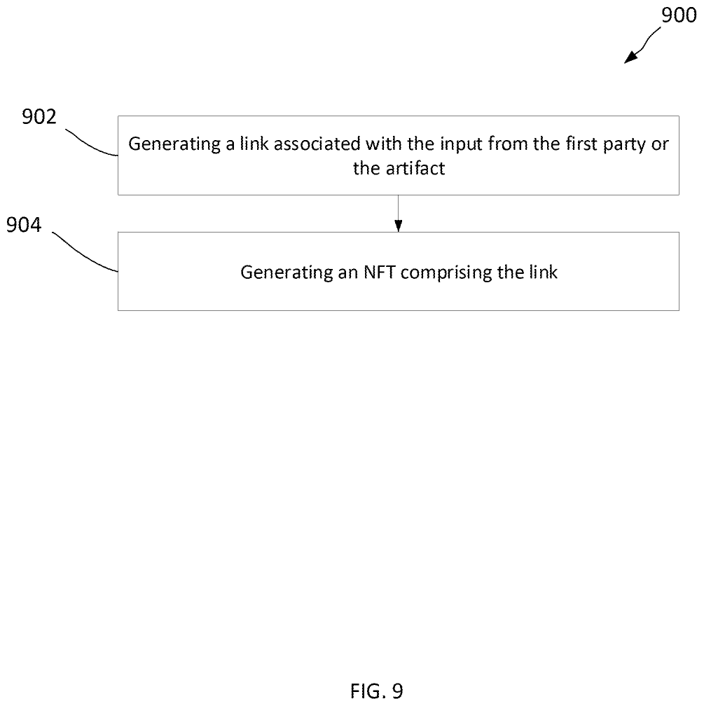

Referring to FIG. 9, a flow diagram of a method 900 for tokenizing the first party input 402 is shown, according to some arrangements. The method 900 may be conducted by the service computing system 334. The service computing system 334 may store the artifact 414 having the first party input 402 in the database 344 of the service computing system 334. The service computing system 334 may also store the artifact 414 having the first party input 402 in the network database including one or more of the databases 320, 332, and 344. As shown, at 902, the service computing system 334 generates a link to the first party input 402 or the artifact 414. The link to the first party input 402 or the artifact 414 identifies where the first party input 402 or the artifact 414 is stored (e.g., database 320, 332, and/or 344). For example, the service computing system 334 may store at least one of the audio, the video, the action virtual coordinates of the body, face, or eye gestures, typing, or clicking of the first party input 402 in the database 344. The service computing system 334 may also generate a link to at least one of the audio, the video, the action virtual coordinates of the body, face, or eye gestures, the typing, or the clicking of the first party input 402.

At 904, tokenizing the at least the portion of the artifact 414 includes the service computing system 334 minting a NFT. The NFT includes metadata that may include the link to the first party input 402 or the artifact 414. In some examples, the metadata of the NFT may include the link to the at least one of the audio, the video, the action virtual coordinates of the body, face, or eye gestures, the typing, or the clicking of the first party input 402. The service computing system 334 may also store the information of the agreement in the database 344 and generate a link to the information. The metadata of the NFT may further include the link to the information. In some examples, the metadata of the NFT may further include the virtual coordinates of the virtual meeting space 120, the virtual coordinates of the first party avatar at recording of the first party input 402 to the artifact 414, the physical coordinates of the first party 302 at the recording of the first party input 402 to the artifact 414, time and date in the physical space of the recording of the first party input 402 to the artifact 414, the first party identifier, the recorded first party identifier, a file size of the artifact 414, a file type of the first party input 402, a language of the first party input 402, and so on.

In some arrangements, the method 900 for tokenizing the first party input 402 may be used for tokenizing the second party input 408. The service computing system 334 may store the artifact 414 having the second party input 408 in the database 344 of the service computing system 334. The service computing system 334 may also store the artifact 414 having the second party input 408 in the network database including one or more of the databases 320, 332, and 344. The service computing system 334 may generate a second link to the second party input 408 or the artifact 414. The link to the second party input 408 or the artifact 414 identifies where the second party input 408 or the artifact 414 is stored. The service computing system 334 may also generate a link to at least one of the audio, the video, the action virtual coordinates of the body, face, or eye gestures, the typing, or the clicking of the second party input 408 stored in the database 344.

The service computing system 334 may tokenize the at least the portion of the artifact 414, which may include the service computing system 334 minting a NFT. The NFT includes metadata that may include the link to the second party input 408 or the artifact 414. In some examples, the metadata of the NFT may include the link to the at least one of the audio, the video, the action virtual coordinates of the body, face, or eye gestures, the typing, or the clicking of the second party input 408. In some examples, the metadata of the NFT may further include the virtual coordinates of the virtual meeting space 120, the virtual coordinates of the second party avatar at recording of the second party input 408 to the artifact 414, the physical coordinates of the second party 304 at the recording of the second party input 408 to the artifact 414, time and date in the physical space of the recording of the second party input 408 to the artifact 414, the second party identifier, the recorded second party identifier, a file type of the second party input 408, a language of the second party input 408, and so on.

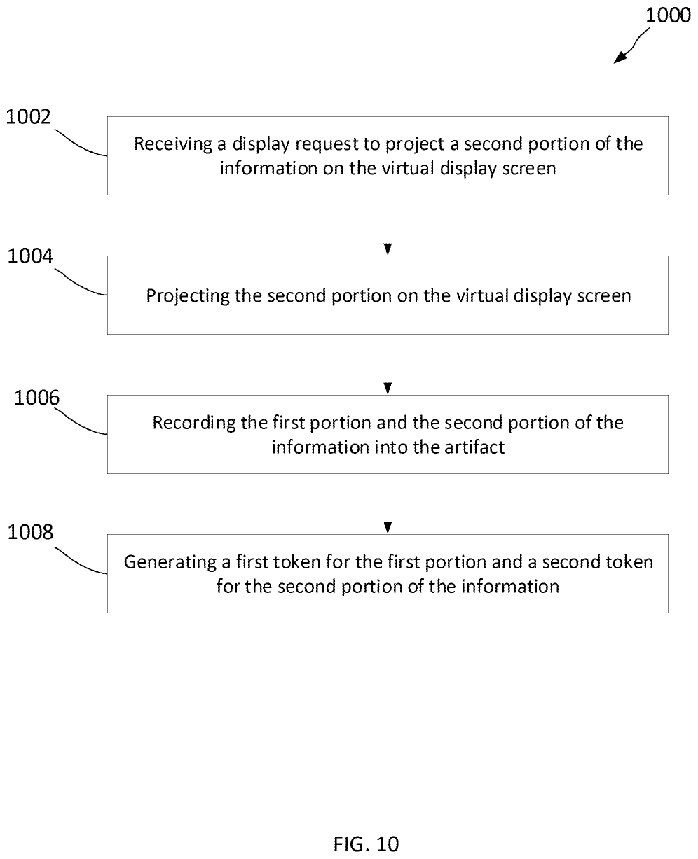

Referring to FIG. 10, a flow diagram of a method 1000 for processing a display request is shown, according to some arrangements. The method 1000 may be conducted by the service computing system 334. In some arrangements, the virtual display screen 130 may be displaying a first portion of the plurality of portions of the information. As shown, at 1002, the service computing system 334 receives, from the first party 302 via the first party computing system 310 or the first user device, a display request to project a second portion of the plurality of portions of the information on the virtual display screen 130. The display request may include a link to the second portion of the plurality of portions of the information, where the link identifies where the second portion of the plurality of portions of the information is stored. The service computing system 334 may receive the display request via the network 308. The service computing system 334 may also receive the display request via mail or fax in physical form addressed to the service provider 306, where the service provider 306 converts the display request from physical form to digital form to be processed by the service computing system 334.

At 1004, the service computing system projects the second portion of the plurality of portions of the information on the virtual display screen 130. Projection of the second portion of the plurality of portions of the information on the virtual display screen 130 may include scrolling on a virtual document presenting the information on the virtual display screen 130, page-turning on the virtual document presenting the information on the virtual display screen 130, and so on. The service computing system 334 may retrieve the information in any file format from the database 344 of the service computing system 334 and convert the information file to be displayed on the virtual display screen 130. At 1004, the service computing system 334 may load the second portion of the plurality of portions of the information from the database 344 to the virtual meeting space 120 and project the information on the virtual display screen 130. In some arrangements, the service computing system 334 may receive the second portion of the plurality of portions of the information in any file format from the first party computing system 310 or the second party computing system 322 and convert the information file to be displayed on the virtual display screen 130. At 1004, the service computing system 334 may receive the second portion of the plurality of portions of the information from the database 320 via the first party computing system 310 or the database 332 via the second party computing system 322, load the second portion of the plurality of portions of the information from the database 320 or the database 332 to the virtual meeting space 120, and project the information on the virtual display screen 130.

At 1006, the service computing system 334 records the first portion of the plurality of portions of the information and the second portion of the plurality of portions of the information into the artifact 414. In some arrangements, the service computing system 334 further generates a first link to the first portion of the plurality of portions of the information and a second link to the second portion of the plurality of portions of the information. The first link identifies where the first portion of the plurality of portions of the information is stored and the second link identifies where the second portion of the plurality of portions of the information is stored.

At 1008, tokenizing the at least the portion of the artifact 414 includes the service computing system 334 minting a first token and a second token. The first token includes metadata that may include the first link. The second token includes metadata that may include the second link. In some arrangements, the first token is a first NFT and the second token is a second NFT. The metadata of the first NFT and/or the second NFT may further include the virtual coordinates of the virtual meeting space 120, the virtual coordinates of the first party avatar and/or the second party avatar at recording of the first party input 402 and/or the second party input 408 to the artifact 414, the physical coordinates of the first party 302 and/or the second party 304 at the recording of the first party input 402 and/or the second party input 408 to the artifact 414, time and date in the physical space of the recording of the first party input 402 and/or the second party input 408 to the artifact 414, the first party identifier, the second party identifier, the recorded first party identifier, the recorded second party identifier, a file size of the artifact 414, a file type of the first party input 402 and/or the second party input 408, a language of the first party input 402 and/or the second party input 408, and so on.

In some arrangements, the method 1000 for processing the display request from the first party 302 may be used for processing a display request from the second party 304. For example, the service computing system 334 may receive the display request to project the second portion of the plurality of portions of the information on the virtual display screen 130 from the second party 304 via the second party computing system 322 or the second user device.

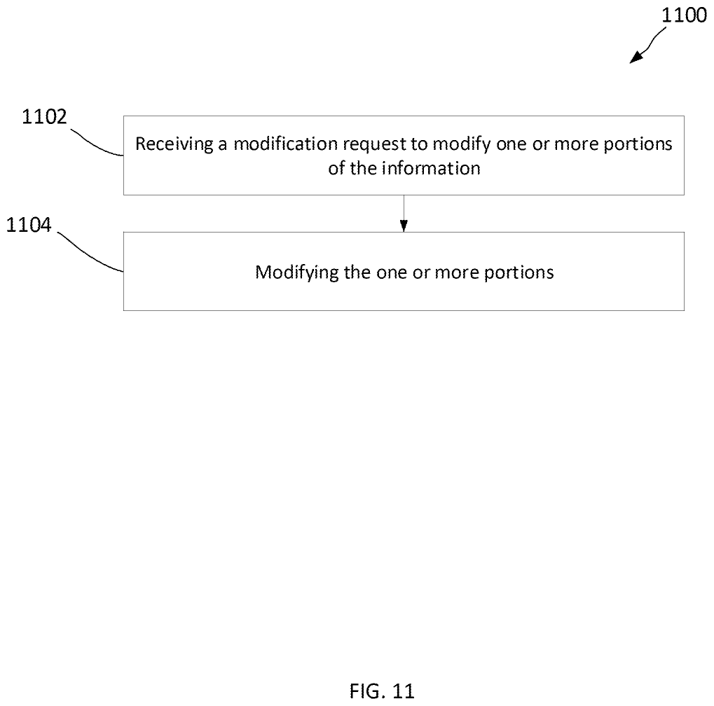

Referring to FIG. 11, a flow diagram of a method 1100 for processing a modification request is shown, according to some arrangements. The method 1100 may be conducted by the service computing system 334. As shown, at 1102, the service computing system 334 receives the modification request to modify one or more portions of the plurality of portions of the information from the first party 302 via the first party computing system 310 or the first user device. In some arrangements, the modification request may include a request for an addition of a new portion and/or a request for a removal of an existing portion of the plurality of portions of the information. The modification request may include a link to the new portion of the information and/or a removed portion of the information, where the link identifies where the new portion of the information and/or the removed portion of the information are stored. The service computing system 334 may receive the modification request via the network 308.

At 1104, based on receiving the modification request, the service computing system 334 modifies the one or more portions of the plurality of portions of the information in accordance with the modification request. The service computing system 334 may retrieve the new portion of the information and/or the removed portion of the information in any file format from the database 344 of the service computing system 334 and convert the new portion of the information and/or the removed portion of the information file to be added to or removed from the agreement. At 1104, the service computing system 334 may (i) go to the link in the modification request to access the new portion of the information and/or the removed portion of the information, (ii) upload the new portion of the information (e.g., adding the new portion of the information, replacing one or more portions of the plurality of portions of the information, etc.) to the information in the database 344, and/or (iii) remove the removed portion of the information (e.g., deleting one or more portions of the plurality of portions of the information, etc.) from the information in the database 344.

In some arrangements, the modification request may be to modify metadata of the information. The metadata of the information may include time and date in the physical space of creation of each of the plurality of portions of the information, virtual coordinates of the first party avatar and/or the second party avatar at creation of each of the plurality of portions of the information, physical coordinates of the first party 302 and/or the second party 304 at the creation of each of the plurality of portions of the information, the first party identifier, the second party identifier, the recorded first party identifier, the recorded second party identifier, a file type of each of the plurality of portions of the information, a language of each of the plurality of portions of the information, and so on.

In some arrangements, the method 1100 for processing the modification request from the first party 302 may be used for processing a modification request from the second party 304. For example, the service computing system 334 may receive the modification request to modify one or more portions of the plurality of portions of the information from the second party 304 via the second party computing system 322 or the second user device.

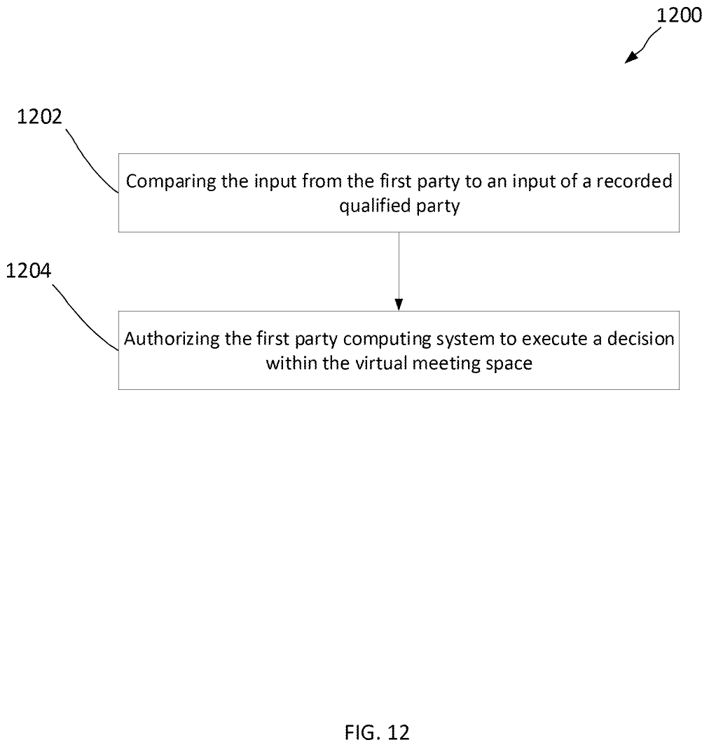

Referring to FIG. 12, a flow diagram of a method 1200 for evaluating the first party state 404 is shown, according to some arrangements. The method 1200 may be conducted by the service computing system 334. As shown, at 1202, the service computing system 334 compares the first party input 402 to an input of a recorded qualified party. In some arrangements, the recorded qualified party may be another party (e.g., similar to the first party 302 and the second party 304) that is not associated with the first party 302, the second party 304, or the agreement. The recorded qualified party may be a third-party associated with an institution (e.g., a financial institution, a law firm, etc.). The first party input 402 includes the first party state 404 and the input from the recorded qualified party includes a qualified party state. The first party state 404 include the first party 302 being awake, asleep, conscious, unconscious, impaired, engaged, disengaged, active, or passive, in the physical space as detected by the first user device. The first party state 404 may be determined using biometric data gathered by the first user device in the physical space. For example, a heartrate sensor of the first user device may detect a heart rate of the first party 302 to determine the first party state 404, an eye-tracking device of the first user device may detect a motion of at least one eye of the first party 302 to determine the first party state 404, a breathalyzer of the first user device may detect a blood alcohol content (BAC) of the first party 302 to determine the first party state 404, a thermometer of the first user device may detect a body temperature of the first party 302 to determine the first party state 404, and so on. The qualified party state includes the recorded qualified party being at least one of awake, conscious, engaged, or active. The qualified party state may be associated with biometric data of the qualified party. In some arrangements, the qualified party state and biometric data of the qualified party are stored in the database 344 of the service computing system 334.

At 1204, based on the first party state 404 matching the qualified party state, the service computing system 334 authorizes the first party 302 to execute a first party decision (e.g., a decision, etc.) within the virtual meeting space 120 via the first party computing system 310 or the first user device. The first party decision may be included in the first party input 402 as a detected action that is detected by the first party computing system 310 or the first user device. The first party decision may include at least one of the first party 302 agreeing to the agreement, the first party 302 rejecting the agreement, the first party 302 modifying the agreement, or the first party 302 requesting for modification of the agreement. In some arrangements, based on the first party state 404 not matching the qualified party state, the service computing system 334 prevents permitting the first party 302 to execute the first party decision within the virtual meeting space 120 via the first party computing system 310 or the first user device. The service computing system 334 may remove the first party avatar from the virtual meeting space 120.

In some arrangements, the method 1200 for evaluating the first party state 404 may be used for evaluating the second party state 410. For example, the service computing system 334 may compare the second party input 408 to the input of the recorded qualified party. The second party input 408 includes the second party state 410. The second party state 410 includes the second party 304 being awake, asleep, conscious, unconscious, impaired, engaged, disengaged, active, or passive, in the physical space as detected by the second user device. The second user device may detect the second party state 410 similarly to how the first user device detects the first party state 404. Based on the second party state 410 matching the qualified party state, the service computing system 334 may authorize the second party 304 to execute a second party decision (e.g., a decision, etc.) within the virtual meeting space 120 via the second party computing system 322 or the second user device. The second party decision may be included in the second party input 408 as a detected action that is detected by the second party computing system 322 or the second user device. The second party decision may include at least one of the second party 304 agreeing to the agreement, the second party 304 rejecting the agreement, the second party 304 modifying the agreement, or the second party 304 requesting for modification of the agreement. In some arrangements, based on the second party state 410 not matching the qualified party state, the service computing system 334 prevents permitting the second party 304 to execute the second party decision within the virtual meeting space 120 via the second party computing system 322 or the second user device. The service computing system 334 may remove the second party avatar from the virtual meeting space 120.

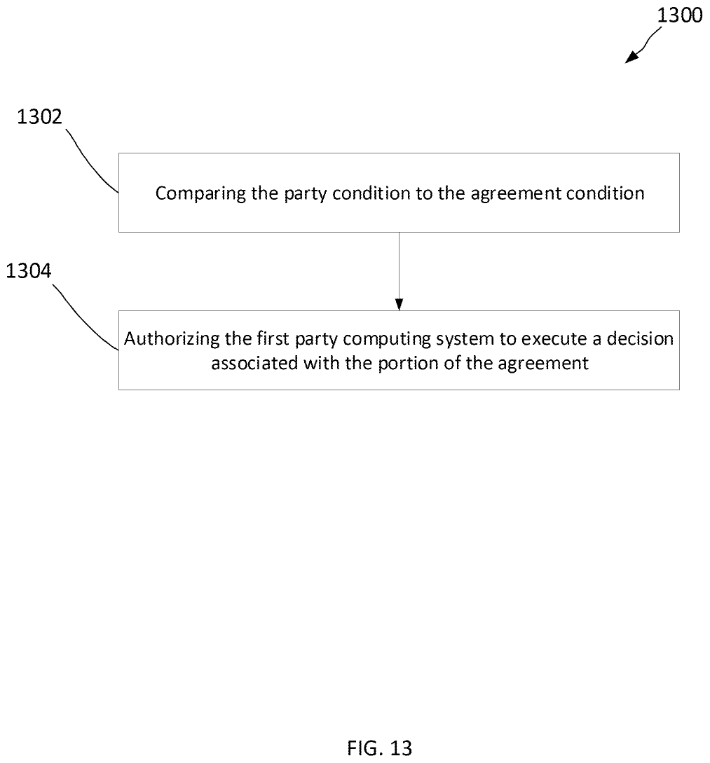

Referring to FIG. 13, a flow diagram of a method 1300 for evaluating the first party condition 406 (e.g., an interpretation of the first party 302) is shown, according to some arrangements. The method 1300 may be conducted by the service computing system 334. The first party input 402 includes the first party condition 406 (e.g., a party condition) of at least a portion of the agreement. The at least the portion of the agreement includes an agreement condition. The agreement condition defines a correct condition (e.g., interpretation, understanding, etc.) of the agreement. The agreement condition may be determined by the service computing system 334 via the service provider 306, a third-party, or AI. In some arrangements, the agreement condition may be the second party condition 412. The first party condition 406 may be determined using voice commands of the first party 302 or body gestures of the first party 302, detected in the physical space via the first user device, in response to receiving (e.g., seeing, hearing, feeling, etc.) the agreement. For example, the first party 302 may verbally state the first party condition 406 into a microphone of the first user device, make a body gesture to convey the first party condition 406 using sensors or cameras of the first user device, and so on.

As shown, at 1302, the service computing system 334 compares the first party condition 406 to the agreement condition. The service computing system 334 may receive the first party condition 406 in any file format from the first party computing system 310 and convert the first party condition 406 file format to match a file format of the agreement condition. In some arrangements, the first party computing system 310 may store the first party condition 406 in the database 320 of the first party computing system 310 and the service computing system 334 may store the agreement condition in the database 344 of the service computing system 334. In some arrangements, comparison between the first party condition 406 and the agreement condition may include a pre-determined tolerance. The pre-determined tolerance may be dependent on a type of the first party condition 406 and the agreement condition. For example, in response to the service computing system 334 determining that the agreement includes an exchange of a blue vehicle, the pre-determined tolerance may be a color shade of the vehicle, where “dark blue car” of the first party condition 406 matches “blue car” of the agreement condition. In some arrangements, the comparison between first party condition 406 and the agreement condition does not include the pre-determined tolerance.

At 1304, based on the first party condition 406 matching the agreement condition, the service computing system 334 authorizes the first party 302 to execute a first partial decision (e.g., the decision for the portion of the agreement) associated with the portion of the agreement within the virtual meeting space 120 via the first party computing system 310 or the first user device. Similar to the first party decision, the first partial decision may be included in the first party input 402 as a detected action that is detected by the first party computing system 310 or the first user device. The first partial decision may include at least one of the first party 302 agreeing to the portion of the agreement, the first party 302 rejecting the portion of the agreement, the first party 302 modifying the portion of the agreement, or the first party 302 requesting for modification of the portion of the agreement. In some arrangements, in response to the service computing system 334 determining that the first party condition 406 does not match the agreement condition, the service computing system 334 may prevent the first party 302 from executing the first partial decision using the first party computing system 310 or the first user device.

In some arrangements, the method 1300 for evaluating the first party condition 406 may be used for evaluating the second party condition 412. The second party input 408 includes the second party condition 412 (e.g., a party condition) of at least a portion of the agreement. Similar to the first party condition 406, the second party condition 412 may be determined using voice commands of the second party 304 or body gestures of the second party 304, detected in the physical space via the second user device, in response to receiving the agreement. The service computing system 334 may compare the second party condition 412 to the agreement condition. Based on the second party condition 412 matching the agreement condition, the service computing system 334 authorizes the second party 304 to execute a second partial decision associated with the portion of the agreement within the virtual meeting space 120 via the second party computing system 322 or the second user device. Similar to the second party decision, the second partial decision may be included in the second party input 408 as a detected action that is detected by the second party computing system 322 or the second user device. The second partial decision may include at least one of the second party 304 agreeing to the portion of the agreement, the second party 304 rejecting the portion of the agreement, the second party 304 modifying the portion of the agreement, or the second party 304 requesting for modification of the portion of the agreement. In some arrangements, in response to the service computing system 334 determining that the second party condition 412 does not match the agreement condition, the service computing system 334 may prevent the second party 304 from executing the second partial decision using the second party computing system 322 or the second user device.

In some arrangements, the service computing system 334 may facilitate evaluation of the first party condition 406 by the second party 304 and the second party condition 412 by the first party 302. For example, the first party condition 406 may be presented via the first party avatar in the virtual meeting space 120 to the second party 304. The second party 304 may determine whether the first party condition 406 matches the second party condition 412. Similarly, the second party condition 412 may be presented via the second party avatar in the virtual meeting space 120 to the first party 302. The first party 302 may determine whether the second party condition 412 matches the first party condition 406.

The service computing system 334 may store positive party reactions and negative party reactions in the database 344. The positive party reactions may include a regular heartrate, a regular body temperature, and the like, of the party. The positive party reactions may also include the party smiling, laughing, clapping, verbally agreeing (e.g., saying “yes,” “yup,” etc.), and so on. The negative party reactions may include a high heartrate, a high body temperature, and the like, of the party. The negative party reactions may also include the party crying, shaking head, waving fingers, shouting, verbally disagreeing (e.g., saying “no,” “nope,” “impossible,” etc.), and so on. In some arrangements, the service computing system 334 may evaluate party condition (e.g., the first party condition 406 and the second party condition 412) based on a party reaction to determine whether conditions match. For example, as the first party condition 406 is presented to the second party 304 in the virtual meeting space 120, the service computing system 334 may determine a second party reaction of the second party 304 to the first party condition 406. The second party reaction may be determined using biometric data (e.g., heartrate, body temperature, etc.), facial reactions, body gestures, and the like, of the second party 304 in the physical space gathered by the second user device. The service computing system 334 may compare the second party reaction to the positive party reaction and the negative party reaction. In response to the service computing system 334 determining that the second party reaction matches the positive party reaction, the service computing system 334 determines that the first party condition 406 and the second party condition 412 match. In response to the service computing system 334 determining that the second party reaction matches the negative party reaction, the service computing system 334 determines that the first party condition 406 and the second party condition 412 do not match. In these arrangements, the second party reaction being positive (e.g., matching the positive party reaction) or negative (e.g., matching the negative party reaction) functions as approval or disapproval of the second party 304 to the first party condition 406. Approval of the second party 304 to the first party condition 406 implies that the second party condition 412 matches the first party condition 406. Disapproval of the second party 304 to the first party condition 406 implies that the second party condition 412 does not match the first party condition 406.

Similarly, the second party condition 412 may be presented to the first party 302 in the virtual meeting space 120, where the service computing system 334 determines a first party reaction of the first party 302 to the second party condition 412. The first party reaction may be determined similarly to the second party reaction in the physical space using the first user device. The service computing system 334 may compare the first party reaction to the positive party reaction and the negative party reaction. In response to the service computing system 334 determining that the first party reaction matches the positive party reaction, the service computing system 334 determines that the first party condition 406 and the second party condition 412 match. In response to the service computing system 334 determining that the first party reaction matches the negative party reaction, the service computing system 334 determines that the first party condition 406 and the second party condition 412 do not match. In these arrangements, the first party reaction being positive or negative functions as approval or disapproval of the first party 302 to the second party condition 412. Approval of the first party 302 to the second party condition 412 implies that the first party condition 406 matches the second party condition 412. Disapproval of the first party 302 to the second party condition 412 implies that the first party condition 406 does not match the second party condition 412.

The detected actions of the first party 302, via the first party computing system 310 or the first user device, and the second party 304, via the second party computing system 322 or the second user device, relate to at least one of the virtual environment 100 or the agreement. The detected actions are detected by at least one of the first party computing system 310, the second party computing system 322, the service computing system 334, the first user device, or the second device.

One detected action may relate to the user devices (e.g., the first user device of the first party 302 and/or the second user device of the second party 304) detecting a body gesture of the party (e.g., the first party 302 and/or the second party 304). The party may hold on to a controller having sensors (e.g., the user device) and wave the controller in a pre-determined sequence. The pre-determined sequence may include pre-determined directions (e.g., up and down, left and right, etc.) of the controller, having physical coordinates in the physical space, at a pre-determined number of times (e.g., three times, four time, ten times, etc.). For example, the party may jump with the controller five times, shake the controller three times, squeeze the controller ten times, and so on. The party may make a pre-determined body-gesture visible to a camera (e.g., the user device) in the physical space. Using AI, the user device determines whether body gestures of the party captured by the camera correspond to the pre-determined body-gestures. For example, the pre-determined body-gesture may be the party jumping five times in view of the camera, falling three times in view of the camera, sitting down ten times in view of the camera, and so on. In some arrangements, the party may make the pre-determined body-gesture while wearing a motion-tracking suit in the physical space. The user device determines whether body gestures of the party captured by the motion-tracking suit correspond to the pre-determined body-gestures. The pre-determined body-gestures may have been pre-recorded by the party on the user device such that the user device can compare the body gestures captured with motion-tracking suit with the pre-recorded body gestures. In some arrangements, the party may make the pre-determined body-gesture while holding a sensor (e.g., an accelerometer sensor, a vibration sensor, etc.) in the physical space. The user device determines whether body gestures of the party captured by the sensor correspond to the pre-determined body-gestures. The pre-determined body-gestures may have been pre-recorded by the party on the user device such that the user device can compare the body gestures captured with the sensor with the pre-recorded body gestures.

Another detected action may relate to the user device detecting a location change of the party in the physical space based on a location change of the user device in the physical space. Using a Global Positioning System (GPS), Wi-Fi location tracking, cellular location tracking, Bluetooth location positioning, Radio Frequency Identification (RFID) tracking, or the like, the user device may detect the location of the user device within the physical coordinates of the physical space, thus determining the location of the party within the physical coordinates of the physical space. For example, the service computing system 334 may have set a pre-determined radius having agreeing physical coordinates within the physical space corresponding to an agreeing location indicating that the party agrees to (e.g., approves, etc.) the agreement. The user device may detect the location of the party in the physical space being within the agreeing physical coordinates based on the location of the user device being within the agreeing physical coordinates within the physical space. Similarly, the service computing system 334 may have set a pre-determined radius having disagreeing physical coordinates within the physical space corresponding to a disagreeing location indicating that the party disagrees to (e.g., disapproves, etc.) the agreement. The user device may detect the location of the party in the physical space being within the disagreeing physical coordinates based on the location of the user device being within the disagreeing physical coordinates within the physical space.

In some arrangements, the user device may detect a location change of the avatar 110 of the party in the virtual environment 100 based on the virtual coordinates of the avatar 110. For example, the service computing system 334 may have set a pre-determined radius having agreeing virtual coordinates within the virtual environment 100 corresponding to an agreeing location indicating that the party agrees to (e.g., approves, etc.) the agreement. The user device may detect the location of the avatar 110 in the virtual environment 100 being within the agreeing virtual coordinates based on the virtual coordinates of the avatar 110 being within the agreeing virtual coordinates within the virtual environment 100. Similarly, the service computing system 334 may have set a pre-determined radius having disagreeing virtual coordinates within the virtual environment 100 corresponding to a disagreeing location indicating that the party disagrees to (e.g., disapproves, etc.) the agreement. The user device may detect the location of the avatar 110 in the virtual environment 100 being within the disagreeing virtual coordinates based on the virtual coordinates of the avatar 110 being within the disagreeing virtual coordinates within the virtual environment 100.

Another detected action may relate to a microphone device of the user device detecting a voice command of the party. For example, the voice command of the party may verbally provide a decision on the agreement.

Another detected action may relate to the first user device detecting a location of the first party 302 in the physical space, based on the location of the first user device in the physical space, being proximate to the second party 304 in the physical space, based on the location of the second user device in the physical space. The first user device of the first party 302 may detect the location of the first party 302 in the physical space being proximate to or within the physical coordinates of the second party 304 based on the location of the first user device within the physical space being proximate to or within the physical coordinates of the second user device. In some arrangements, the physical space proximate to the physical coordinates of the second user device may be a room in a building, a building, a house, a neighborhood, a city, a state, a country, a continent, and so on, in the physical space.

In some arrangements, the first user device may detect a location of the first party avatar in the virtual environment 100, based on the virtual coordinates of the first party avatar in the virtual environment 100, being proximate to the second party avatar in the virtual environment 100, based on the virtual coordinates of the second party avatar in the virtual environment 100. The first user device of the first party 302 may detect the location of the first party avatar in the virtual environment 100 being proximate to or within the virtual coordinates of the second party avatar based on the virtual coordinates of the first party avatar being proximate to or within the virtual coordinates of the second party avatar.

Another detected action may relate to the service computing system 334 detecting a lack of meeting between the first party avatar and the second party avatar in the virtual meeting space 120 for a period of time. In some arrangements, the period of time may be two weeks (e.g., 14 days). In some arrangements, the period of time may be shorter than two weeks (e.g., one week, one day, etc.) or longer than two weeks (e.g., three weeks, one month, etc.).

Another detected action may relate to the service computing system 334 detecting a change in market value of the agreement that exceeds a pre-determined threshold. In some arrangements, the pre-determined threshold is +/−10% of an original market value of the agreement. In some arrangements, the pre-determined threshold is +/−50% of the original market value of the agreement.

In some arrangements, the service provider 306, or a third-party insurance institution, may provide an insurance on the agreement. The insurance would provide compensation to an affected party (e.g., the first party 302 or the second party 304) in an event of the agreement being breached. For example, in response to the service computing system 334 determining that the agreement is breached by the first party 302, the service provider 306 or the third-party insurance institution compensates the second party 304 according a value of the breach. In some arrangements, compensation may be in a form of money (e.g., monetary compensation), services, goods, materials, or the like. Compensation may be associated with the portions of the agreement that was breached or may have been set (e.g., determined, etc.) prior to the breach. Compensation for the breach may have also been included in the agreement. An insurance premium (e.g., a cost of insurance, etc.) may be positively correlated to a market value of the agreement. The market value of the agreement may be determined by summing a total monetary value of agreement, including assets, money, service, goods, materials, or the like. The market value of the agreement may also include monetary value of the compensations associated with the breach of the agreement. In some arrangements, the agreement includes a resolution clause defining compensation for breaching the agreement.

The first party computing system 310, the second party computing system 322, the service computing system 334, the first user device, and/or the second user device may be configured to detect breaches of the agreement. For example, a portion of an agreement for house sitting might require a sound level, detected by the first user device, to not exceed a pre-determined level (e.g., 100 decibels, etc.). In response to determining that the first user device detects a house sitter, the second party 304, to have exceeded the pre-determined level, the first user device notifies the service computing system 334 of the breach. The service computing system 334 may allow for the second party 304 to dispute the breach. For example, the second party 304 may, using the second user device, assert that the pre-determined level was breached due to a vacuum noise. The information of the house sitting agreement may have required the house sitter to vacuum the house. In response, the service provider 306, via the service computing system 334, may reject the breach claim made by the first user device and mark the agreement as unbreached.

In some arrangements, the agreement may be a virtual asset (e.g., a digital asset, etc.) owned by the service provider 306. For example, the service computing system 334 may have the virtual asset in a service digital wallet (e.g., the digital wallet for the service provider 306), which provides the service provider 306, via the service digital wallet, the private key to the virtual asset that controls access to the virtual asset. In some arrangements, in response to the service computing system 334 determining that the first party 302 and the second party 304 made a decision to agree to the agreement, the service provider 306 may provide the first party 302 and the second party 304 access to the service digital wallet, which includes the virtual asset. For example, the service computing system 334 may provide the first party 302, via the first party computing system 310 or the first user device, and the second party 304, via the second party computing system 322 or the second user device, a backup phrase (e.g., a seed phrase, a 12 or 24-word phrase, etc.) associated with the service digital wallet, where the backup phrase provides complete access to the service digital wallet.

In some arrangements, in response to the service computing system 334 determining that the first party 302 and the second party 304 made a decision to agree to the agreement, the service provider 306 may transfer ownership of the virtual asset to the first party 302 and the second party 304. For example, the first party 302 the second party 304 may be partial owners of the virtual asset. Partial ownership (e.g., fractional ownership, etc.) of the virtual asset fractionalizes (e.g., divides, etc.) the virtual asset, generating at least two portions of the virtual asset that are linked to the virtual asset. Each of the at least two portions of the virtual asset includes a unique private key. The service computing system 334 may fractionalize the virtual asset using a smart contract. A partial owner (e.g., the first party 302, the second party 304, and/or the service provider 306) of the virtual asset has one of the at least two portions of the virtual asset in a partial owner digital wallet (e.g., the digital wallet for the partial owner), which provides the partial owner, via the partial owner digital wallet, the private key to the one of the at least two portions of virtual asset that controls access to the corresponding one of the at least two portions of the virtual asset. In some arrangements, the service provider 306 may retain partial ownership in the virtual asset, such that the first party 302, the second party 304, and the service provider 306 are partial owners of the virtual asset. Ownership of the service provider 306 in the virtual asset may be very small (e.g., 0.1%, 0.01%, 0.001%, etc.), which may be detailed in the smart contract. The service provider 306 may interpret its ownership in the virtual asset as compensation for the virtual meeting space 120 provided by the service computing system 334.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor that, in some arrangements, may execute instructions stored, or otherwise accessed, via different areas of memory). Alternatively or additionally, the one or more processors may be structured to perform or otherwise execute certain operations independent of one or more co-processors. In some arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In some arrangements, the volatile storage media may take the form of RAM, TRAM, ZRAM, etc. Combinations of the above are also included within the scope of machine-readable media. In this regard, machine-executable instructions comprise, for example, instructions and data that cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the arrangements described herein.

It should also be noted that the term “input devices,” as described herein, may include any type of input device including, but not limited to, video and audio recording devices, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

1. A method comprising:
generating, by a service computing system, a virtual environment;
permitting, by the service computing system, a first party into the virtual environment;
generating, by the service computing system, a secure virtual meeting space within the virtual environment, the virtual meeting space being invisible to unauthorized parties within the virtual environment;
receiving, by the service computing system from a first party computing system, a first party entrance request of the first party to enter into the virtual meeting space, the first party entrance request comprising a first party authentication token, the first party authentication token comprising a first party identifier;
comparing, by the service computing system, the first party identifier to a recorded first party identifier;
based on the first party identifier matching the recorded first party identifier, authorizing, by the service computing system, the first party into the virtual meeting space such that the virtual meeting space is visible to the first party;
in response to authorizing the first party into the virtual meeting space, projecting, by the service computing system, information on a virtual monitor within the virtual meeting space while the information is projected on the virtual monitor;
recording, by the service computing system using a user device, input from the first party within the virtual meeting space into an artifact;
storing, by the service computing system, the artifact in a database;
generating, by the service computing system, a link to the artifact; and
tokenizing, by the service computing system, at least a portion of the artifact into a token comprising the link.

2. The method of claim 1, further comprising:
receiving, by the service computing system from a second party computing system, a second party entrance request of a second party to enter into the virtual meeting space, the second party entrance request comprising a second party authentication token, the second party authentication token comprising a second party identifier;
comparing, by the service computing system, the second party identifier to a recorded second party identifier;
based on the second party identifier matching the recorded second party identifier, authorizing, by the service computing system, the second party into the virtual meeting space; and
recording, by the service computing system using a second user device, input from the second party within the virtual meeting space into the artifact.

3. The method of claim 1, further comprising:
comparing, by the service computing system, the first party identifier and the recorded first party identifier with a blacklist, the blacklist comprising a plurality of identifiers associated with fraudulent parties, each of the fraudulent parties having a fraudulent transaction history; and
based on the first party identifier and the recorded first party identifier matching one or more of the plurality of identifiers of the blacklist:
notifying, by the service computing system, a second party through a second party computing system that the first party is on the blacklist, or
disallowing, by the service computing system, the first party from entering the virtual meeting space.

4. The method of claim 1, further comprising:
comparing, by the service computing system, the first party identifier and the recorded first party identifier with a whitelist, the whitelist comprising a plurality of identifiers associated with trusted parties, each of the trusted parties having a positive transaction history; and
based on the first party identifier and the recorded first party identifier matching one or more of the plurality of identifiers of the whitelist:
notifying, by the service computing system, a second party through a second party computing system that the first party is on the whitelist, or
allowing, by the service computing system, the first party to enter the virtual meeting space.

5. The method of claim 1, wherein the input from the first party comprises at least one of a sound, a video, a body gesture, a face gesture, or an eye gesture of the first party detected by the user device, and the input from the first party corresponds to consent of the first party to at least one portion of the information projected on the virtual monitor.

6. The method of claim 5, further comprising generating, by the service computing system, a link associated with the input from the first party or the artifact,
wherein tokenizing the at least the portion of the artifact comprises minting, by the service computing system, a Non-Fungible Token (NFT) comprising the link.

7. The method of claim 1, wherein the virtual monitor occupies a two-dimensional area or a three-dimensional volume within the virtual meeting space.

8. The method of claim 1, wherein the information is text from a document.

9. The method of claim 1, wherein:
the information comprises a plurality of portions;
the virtual monitor projects a first portion of the plurality of portions; and
the method further comprising:
receiving, by the service computing system from the first party computing system, a display request to project a second portion of the plurality of portions on the virtual monitor, and
projecting, by the service computing system, the second portion of the plurality of portions on the virtual monitor.

10. The method of claim 9, further comprising:
recording, by the service computing system, the first portion of the plurality of portions of the information and the second portion of the plurality of portions of the information into the artifact; and
wherein tokenizing the at least the portion of the artifact comprises generating, by the service computing system, a first token for the first portion of the plurality of portions of the information and a second token for the second portion of the plurality of portions of the information.

11. The method of claim 1, wherein:
the information comprises a plurality of portions; and
the method further comprising:
receiving, by the service computing system from the first party computing system, a modification request to modify one or more portions of the plurality of portions, and
based on receiving the modification request, modifying, by the service computing system, the one or more portions of the plurality of portions.

12. The method of claim 1, wherein the first party identifier and the recorded first party identifier comprise at least one of:
a facial feature, detected by a camera device of the user device, of the first party;
a fingerprint, detected by a fingerprint scanner of the user device, of the first party;
a voice command, detected by a microphone device of the user device, of the first party;
a social media account, detected by the user device, of the first party;
an Internet Protocol (IP) address of the first party computing system or the user device;
a Media Access Control (MAC) address of the first party computing system or the user device;
a Global Positioning System (GPS) address of the first party computing system or the user device;
a device identifier of the first party computing system or the user device;
a transaction history of the first party;
a credit score of the first party;
a transaction rating of the first party based on the transaction history of the first party; or
a testimony about the first party from a third-party.

13. The method of claim 1, wherein the user device comprises at least one of an augmented reality goggle, a virtual reality goggle, a phone, a tablet, a motion-tracking suit, a hologram system, or a haptic feedback olfactory device.

14. The method if claim 1, further comprising:
comparing, by the service computing system, the input from the first party to an input of a recorded qualified party, wherein the input from the first party comprises a first party state, and wherein the input from the recorded qualified party comprises a qualified party state;
based on the first party state matching the qualified party state, authorizing, by the service computing system, the first party computing system to execute a decision within the virtual meeting space,
wherein the decision comprises at least one of the first party agreeing to an agreement, the first party rejecting the agreement, the first party modifying the agreement, or the first party requesting for a modification of the agreement,
wherein the first party state comprises the first party being, detected by the user device, awake, asleep, conscious, unconscious, impaired, engaged, disengaged, active, or passive, and
wherein the qualified party state comprises the recorded qualified party being at least one of awake, conscious, engaged, or active.

15. The method of claim 1, wherein:
the input from the first party comprises a party condition of at least a portion of an agreement, the portion of the agreement comprising an agreement condition; and
the method further comprises:
comparing, by the service computing system, the party condition to the agreement condition, and
based on the party condition matching the agreement condition, authorizing, by the service computing system, the first party computing system to execute a decision associated with the portion of the agreement within the virtual meeting space, wherein the decision associated within the portion of the agreement comprises at least one of the first party agreeing to the portion of the agreement, the first party rejecting the portion of the agreement, the first party modifying the portion of the agreement, or the first party requesting for a modification of the portion of the agreement.

16. The method of claim 1, further comprising receiving, by the service computing system from the first party computing system, a meeting space generation request to generate the virtual meeting space,
wherein the meeting space generation request comprises at least one of a meeting time, a name of the first party, a house or a business address of the first party, a purpose of meeting, a type of an agreement, a market value of the agreement, or a time length of the agreement.

17. The method of claim 1, wherein tokenizing the portion of the artifact comprises minting, by the service computing system, of a Non-Fungible Token (NFT).

18. A system comprising one or more processors and a memory storing instructions that are executable by the one or more processors to perform operations comprising:
generate a virtual environment;
permit a first party into the virtual environment;
generate a secure virtual meeting space within the virtual environment, the virtual meeting space being invisible to unauthorized parties within the virtual environment;
receive a first party entrance request of the first party to enter into the virtual meeting space, the first party entrance request comprising a first party authentication token, the first party authentication token comprising a first party identifier;
compare the first party identifier to a recorded first party identifier;
based on the first party identifier matching the recorded first party identifier, authorize the first party into the virtual meeting space such that the virtual meeting space is visible to the first party;
in response to authorizing the first party into the virtual meeting space, project information on a virtual monitor within the virtual meeting space while the information is projected on the virtual monitor;
record input from the first party within the virtual meeting space into an artifact;
store the artifact in a database;
generate a link to the artifact; and
tokenize at least a portion of the artifact into a token comprising the link.

19. The system of claim 18, the operations further comprising:
receive a second party entrance request of a second party to enter into the virtual meeting space, the second party entrance request comprising a second party authentication token, the second party authentication token comprising a second party identifier;
compare the second party identifier to a recorded second party identifier;
based on the second party identifier matching the recorded second party identifier, authorize the second party into the virtual meeting space; and
record input from the second party within the virtual meeting space into the artifact.

20. A non-transitory computer-readable storage medium storing instructions that are executable by one or more processors to perform operations comprising:
generating, by a service computing system, a virtual environment;
permitting, by the service computing system, a first party into the virtual environment;
generating, by the service computing system, a secure virtual meeting space within the virtual environment, the virtual meeting space being invisible to unauthorized parties within the virtual environment;
receiving, by the service computing system from a first party computing system, a first party entrance request of the first party to enter into the virtual meeting space, the first party entrance request comprising a first party authentication token, the first party authentication token comprising a first party identifier;
comparing, by the service computing system, the first party identifier to a recorded first party identifier;
based on the first party identifier matching the recorded first party identifier, authorizing, by the service computing system, the first party into the virtual meeting space such that the virtual meeting space is visible to the first party;
in response to authorizing the first party into the virtual meeting space, projecting, by the service computing system, information on a virtual monitor within the virtual meeting space while the information is projected on the virtual monitor;
recording, by the service computing system using a user device, input from the first party within the virtual meeting space into an artifact;
storing, by the service computing system, the artifact in a database;
generating, by the service computing system, a link to the artifact; and
tokenizing, by the service computing system, at least a portion of the artifact into a token comprising the link.
